(19) United States
(12) Patent Application Publication
(10) Pub. No.: US 2016/0323283 A1
(43) Pub. Date: Nov. 3, 2016

(54) SEMICONDUCTOR DEVICE FOR CONTROLLING ACCESS RIGHT TO RESOURCE BASED ON PAIRING TECHNIQUE AND METHOD THEREOF

(71) Applicant: SAMSUNG ELECTRONICS CO., LTD., SUWON-SI (KR)

(72) Inventors: BO GYEONG KANG, SEOUL (KR); MYUNG KOO KANG, SEOUL (KR); BYUNG SE SO, SEOUL (KR); SANG HWA JIN, SEONGNAM-SI (KR)

(21) Appl. No.: 15/143,008

(22) Filed: Apr. 29, 2016

Related U.S. Application Data
(60) Provisional application No. 62/155,107, filed on Apr. 30, 2015.
(60) Provisional application No. 62/185,899, filed on Jun. 29, 2015.

(30) Foreign Application Priority Data
Jul. 20, 2015 (KR) 10-2015-0102304

(51) Int. Cl. H04L 29/06

(52) U.S. Cl. CPC H04L 63/10; H04L 63/08

(57) ABSTRACT

A method of operating a hub includes the hub receiving a pairing request from an Internet of Things (IoT) device, the hub performing pairing with the IoT device using one authentication technique from among a plurality of predetermined pairing authentication techniques, and the hub assigning an access right to a resource to the IoT device. The access right is determined according to the one authentication technique.

### CROSS-REFERENCE TO RELATED APPLICATIONS

This application claims priority under 35 U.S.C. §119 to U.S. Provisional Patent Application No. 62/155,107 filed on Apr. 30, 2015, U.S. Provisional Patent Application No. 62/185,899 filed on Jun. 29, 2015, and Korean Patent Application No. 10-2015-0102304 filed on Jul. 20, 2015, the entire disclosures of which are hereby incorporated by reference in their entireties.

### TECHNICAL FIELD

Exemplary embodiments of the inventive concept relate to a semiconductor device, and more particularly, to a semiconductor device for controlling an access right to a resource based on a pairing technique used with respect to an Internet of Things (IoT) device, and a method thereof.

### DISCUSSION OF THE RELATED ART

The Internet of Things (IoT) refers to a technique of connecting things embedded with a sensor and having Internet connectivity. Here, the things are embedded systems such as home appliances, mobile equipment, wearable computers, etc. In the IoT, each thing has a unique IP address to identify itself when it is connected to the Internet, and has a sensor embedded therein to obtain data from external environments.

The IoT may be a target for hacking. When at least one IoT device is used by a malicious user in an IoT network system, security of the IoT network system may be compromised, and the IoT network system may be damaged.

### SUMMARY

According to an exemplary embodiment of the inventive concept, a method of operating a hub includes the hub receiving a pairing request from an Internet of Things (IoT) device, the hub performing a pairing operation with the IoT device using one authentication technique from among a plurality of predetermined pairing authentication techniques, and the hub assigning an access right to a resource to the IoT device. The access right may be determined according to the one authentication technique. Performing the pairing may include the hub selecting the one authentication technique from among the predetermined pairing authentication techniques using an authentication request signal included in the pairing request, and the hub evaluating an authentication grade for the one authentication technique.

The authentication request signal may include an identifier (ID), a password, a media access control (MAC) address, a WI-FI protected access (WPA)-related signal, a WI-FI protected access II (WPA2)-related signal, a digital signature, an ID-based encryption-related signal, or a biometrics-related signal.

Assigning the IoT device the access right to the resource may include the hub receiving data from the IoT device and analyzing the data, the hub determining one of a plurality of cluster types as a cluster type of the IoT device according to an analysis result of the data, and the hub determining the access right to the resource using at least one of the evaluated authentication grade and the cluster type.

The method may further include the hub monitoring a usage of the resource used by the IoT device, and the hub adjusting the access right to the resource in real-time according to a monitoring result.

The resource may include at least one of a bandwidth of a channel formed between the hub and the IoT device, the amount of power of the hub consumed by the IoT device, at least one hardware component included in the hub, at least one software component included in the hub, another IoT device paired with the hub, an update period of data transmitted from the IoT device, and a pairing duration time between the hub and the IoT device.

The hub may use one of a signal strength of the IoT device, position information regarding the IoT device, and a response speed of the IoT device as the one authentication technique. The hub may determine the access right to the resource differently according to the pairing authentication techniques.

According to an exemplary embodiment of the inventive concept, a semiconductor device includes a communication module configured to receive a pairing request from an IoT device, and a processor configured to communicate with the communication module. The processor may select one authentication technique from among a plurality of predetermined pairing authentication techniques in response to the pairing request, authenticate the IoT device using the selected authentication technique, control the communication module to facilitate pairing with the IoT device, and assign an access right to a resource to the IoT device. The access right may be determined according to the one authentication technique.

The semiconductor device may further include a hardware secure module configured to store the predetermined pairing authentication techniques. The processor may select the one authentication technique from among the predetermined pairing authentication techniques using an authentication request signal included in the pairing request and the predetermined pairing authentication techniques stored in the hardware secure module, and may evaluate an authentication grade for the selected authentication technique.

The authentication request signal may include at least one of an ID, a password, a MAC address, a WPA-related signal, a WPA2-related signal, a digital signature, an ID-based encryption-related signal, or a biometrics-related signal.

The communication module may receive data from the IoT device paired with the semiconductor device, and the processor may analyze the data output from the communication module, determine one of a plurality of cluster types as a cluster type of the IoT device according to an analysis result, and determine the access right to the resource using at least one of the authentication grade and the cluster type.

The processor may monitor a usage of the resource used by the IoT device paired with the semiconductor device, and adjust the access right to the resource in real-time according to a monitoring result.

The processor may be configured to check an authentication history of the IoT device using an authentication request signal included in the pairing request and authentication information stored in the hardware secure module, generate a confirmation signal, select the one authentication technique from among the predetermined pairing authentication techniques in response to the confirmation signal, authenticate the IoT device using the selected authentication technique, store first authentication information corresponding to an authentication result in the hardware secure module, evaluate an authentication grade of the IoT device using the first authentication information, and determine the access right to the resource based on the evaluated authentication grade.

The processor may further be configured to monitor a usage of the resource used by the IoT device paired with the semiconductor device, and adjust the access right to the resource in real-time according to the monitoring result.

The processor may further be configured to analyze the data output from the communication module, determine one of the plurality of cluster types as the cluster type of the IoT device according to the analysis result, and determine the access right to the resource using at least one of the evaluated authentication grade and the determined cluster type.

According to an exemplary embodiment of the inventive concept, a method of operating a hub includes receiving, by the hub, a first plurality of pairing requests and a first plurality of data from a first plurality of Internet of Things (IoT) devices, receiving, by the hub, a second plurality of pairing requests and a second plurality of data from a second plurality of IoT devices, classifying, by the hub, the first plurality of IoT devices as a first cluster type based on the first plurality of data, and classifying, by the hub, the second plurality of IoT devices as a second cluster type based on the second plurality of data. The first and second cluster types correspond to different types of IoT devices. The method further includes performing, by the hub, a pairing operation with the first plurality of IoT devices using a first authentication technique from among a plurality of predetermined pairing authentication techniques, performing, by the hub, a pairing operation with the second plurality of IoT devices using a second authentication technique from among the plurality of predetermined pairing authentication techniques, assigning, by the hub, a first access right to a resource to the first plurality of IoT devices classified as the first cluster type, and assigning, by the hub, a second access right to the resource to the second plurality of IoT devices classified as the second cluster type. The first and second access rights are determined according to the first and second authentication techniques.

In an exemplary embodiment, the first cluster type corresponds to IoT devices that gather first information, and the second cluster type corresponds to IoT devices that gather second information different from the first information.

In an exemplary embodiment, performing the pairing operation with the first and second pluralities of IoT devices includes selecting, by the hub, the first authentication technique from among the plurality of predetermined pairing authentication techniques using an authentication request signal included in the first plurality of pairing requests, selecting, by the hub, the second authentication technique from among the plurality of predetermined pairing authentication techniques using an authentication request signal included in the second plurality of pairing requests, and evaluating, by the hub, an authentication grade for the first and second authentication techniques.

In an exemplary embodiment, the authentication request signal included in the first and second pluralities of pairing requests includes one of an identifier (ID), a password, a media access control (MAC) address, a WI-FI protected access (WPA)-related signal, a WI-FI protected access II (WPA2)-related signal, a digital signature, an ID-based encryption-related signal, and a biometrics-related signal.

In an exemplary embodiment, the resource includes at least one of a bandwidth of a channel formed between the hub and each of the IoT devices, an amount of power of the hub consumed by each of the IoT devices, a hardware component included in the hub, a software component included in the hub, an update period of data transmitted from each of the IoT devices, and a pairing duration time between the hub and each of the IoT devices.

### BRIEF DESCRIPTION OF THE DRAWINGS

The above and other features of the inventive concept will become more apparent by describing in detail exemplary embodiments thereof with reference to the accompanying drawings, in which:

FIG. 1 is a block diagram of a data processing system according to exemplary embodiments of the inventive concept;

FIG. 2 is a block diagram of a processing module for controlling an access right to a resource using a pairing technique used with respect to an Internet of Things (IoT) device according to exemplary embodiments of the inventive concept;

FIG. 3 is a schematic flowchart of the operation of the processing module illustrated in FIG. 2 according to an exemplary embodiment of the inventive concept;

FIG. 4 is a detailed flowchart of the operation of the processing module illustrated in FIG. 2 according to an exemplary embodiment of the inventive concept;

FIG. 5 is a diagram of pairing authentication techniques used in the processing module illustrated in FIG. 2 according to an exemplary embodiment of the inventive concept;

FIG. 6 is a diagram of access rights to resources defined for each cluster type and/or each device according to an exemplary embodiment of the inventive concept;

FIG. 7 is a block diagram of a data processing system including a hub illustrated in FIG. 1 according to an exemplary embodiment of the inventive concept;

FIG. 8 is a block diagram of a data processing system including the hub illustrated in FIG. 1 according to an exemplary embodiment of the inventive concept;

FIG. 9 is a block diagram of a data processing system including the hub illustrated in FIG. 1 according to an exemplary embodiment of the inventive concept;

FIG. 10 is a block diagram of an example of the hub illustrated in FIG. 1 according to an exemplary embodiment of the inventive concept;

FIG. 11 is a block diagram of an example of the hub illustrated in FIG. 1 according to an exemplary embodiment of the inventive concept;

FIG. 12 is a block diagram of an example of the hub illustrated in FIG. 1 according to an exemplary embodiment of the inventive concept;

FIG. 13 is a block diagram of an example of the hub illustrated in FIG. 1 according to an exemplary embodiment of the inventive concept;

FIG. 14 is a block diagram of an example of the hub illustrated in FIG. 1 according to an exemplary embodiment of the inventive concept;

FIG. 15 is a block diagram of a data processing system including the hub illustrated in FIG. 1 according to an exemplary embodiment of the inventive concept;

FIG. 16 is a block diagram of a data processing system including the hub illustrated in FIG. 1 according to an exemplary embodiment of the inventive concept;

FIG. 17 is a block diagram of a data processing system including the hub illustrated in FIG. 1 according to an exemplary embodiment of the inventive concept;

FIG. 18 is a block diagram of a data processing system including the hub illustrated in FIG. 1 according to an exemplary embodiment of the inventive concept; and

FIG. 19 is a block diagram of a data processing system including the hub illustrated in FIG. 1 according to an exemplary embodiment of the inventive concept.

### DETAILED DESCRIPTION OF THE EXEMPLARY EMBODIMENTS

Exemplary embodiments of the inventive concept will be described more fully hereinafter with reference to the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity. Like reference numerals may refer to like elements throughout the accompanying drawings.

It will be understood that when an element is referred to as being “connected” or “coupled” to another element, it can be directly connected or coupled to the other element, or intervening elements may be present.

It will be understood that, although the terms first, second, etc. may be used herein to describe various elements, these elements should not be limited by these terms. These terms are only used to distinguish one element from another. For example, a first signal could be termed a second signal, and, similarly, a second signal could be termed a first signal without departing from the teachings of the disclosure.

The terminology used herein is for the purpose of describing particular embodiments only and is not intended to be limiting of the invention. As used herein, the singular forms “a”, “an” and “the” are intended to include the plural forms as well, unless the context clearly indicates otherwise.

Pairing is a procedure for registering information (e.g., pairing information) regarding a second device in a first device for the purpose of wirelessly connecting the second device (e.g., an Internet of Things (IoT) device) to the first device (e.g., a master device or a hub). Hereinafter, pairing for authentication may be referred to as pairing authentication. Once the first device and the second devices are paired with each other, further pairing may not be necessary between the first and second devices since the pairing information of the second device has been registered in the first device. However, when the pairing information of the second device is deleted from the first device, pairing between the first device and second device may be performed again.

Herein, it is to be understood that the term “thing” collectively refers to an integrated circuit (IC), a semiconductor device, a semiconductor package, an electronic device, or an IoT device. The semiconductor device may be implemented as, for example, a module or a system in package (SiP). Herein, the terms module and circuit may be used interchangeably. For example, the communication module, hardware secure module, etc. described herein may also be referred to as a communication circuit, hardware secure circuit, etc.

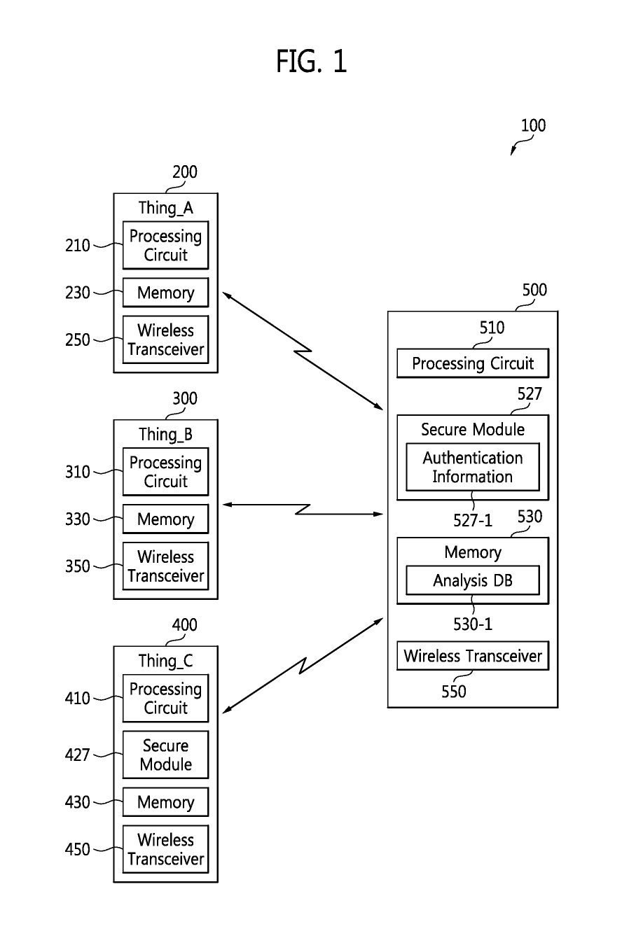

FIG. 1 is a block diagram of a data processing system 100 according to exemplary embodiments of the inventive concept. Referring to FIG. 1, the data processing system 100 may include a plurality of IoT devices 200, 300, and 400 and a semiconductor device 500. The semiconductor device 500 may be, for example, a master device or a hub, but is not limited thereto. Herein, the semiconductor device 500 may be referred to as the hub 500.

It is assumed that the first IoT device 200 is a device (e.g., a thing) connected to the hub 500 without security authentication, the second IoT device 300 is a device (e.g., a thing) connected to the hub 500 with limited security authentication, and the third IoT device 400 is a device (e.g., a thing) connected to the hub 500 using a security authentication platform.

For example, the security level of the second IoT device 300 may be higher than that of the first IoT device 200, and the security level of the third IoT device 400 may be higher than that of the second IoT device 300. The third IoT device 400 and the hub 500 may use, for example, a SAMSUNG ARTIK security platform. However, exemplary embodiments of the inventive concept are not limited thereto.

As described above, each of the devices 200, 300, 400, and 500 may be implemented as an IoT device. However, exemplary embodiments of the inventive concept are not limited thereto. The IoT device, which will be described hereinafter, may include an accessible interface (e.g., a wired interface and/or a wireless interface). The IoT device may refer to a device which can communicate data (e.g., via a wired or wireless connection) with at least one electronic device, including another IoT device, using the accessible interface.

The accessible interface may include, for example, a local area network (LAN), a wireless LAN (WLAN) such as Wi-Fi, a wireless personal area network (WPAN) such as BLUETOOTH, a wireless universal serial bus (USB), ZIGBEE, near field communication (NFC), radio-frequency identification (RFID), or a mobile cellular network. However, exemplary embodiments of the inventive concept are not limited thereto. The mobile cellular network may include, for example, a third generation (3G) mobile cellular network, a fourth generation (4G) mobile cellular network, a long term evolution (LTE) mobile cellular network, or an LTE-advanced (LTE-A) mobile cellular network. However, exemplary embodiments of the inventive concept are not limited thereto.

The first IoT device 200 may include a processing circuit 210, a memory 230, and a communication module 250 (e.g., a wireless or wired transceiver). The processing circuit 210 may control the memory 230 and the communication module 250. The processing circuit 210 may be, for example, an integrated circuit (IC), a processor, or a central processing unit (CPU). The processing circuit 210 may transmit or receive a command and/or data for pairing with the hub 500 through the communication module 250. For example, when the first IoT device 200 includes at least one sensor, the processing circuit 210 may process a signal detected by the sensor and may transmit the processed signal to the hub 500 through the communication module 250.

The memory 230 may store data that has been processed or that is to be processed by the processing circuit 210 or the communication module 250. The communication module 250 may transmit or receive a command and/or data with the hub 500 according to the control of the processing circuit 210. The communication module 250 may be, for example, a wireless transceiver, and may communicate with the hub 500 through the above-described accessible interface.

The second IoT device 300 may include a processing circuit 310, a memory 330, and a communication module 350 (e.g., a wireless or wired transceiver). The processing circuit 310 may control the memory 330 and the communication module 350. The processing circuit 310 may be, for example, an IC, a processor, or a CPU. The processing circuit 310 may transmit or receive a command and/or data for pairing with the hub 500 through the communication module 350. For example, when the second IoT device 300 includes at least one sensor, the processing circuit 310 may process a signal detected by the sensor and may transmit the processed signal to the hub 500 through the communication module 350.

The memory 330 may store data that has been processed or that is to be processed by the processing circuit 310 or the communication module 350. The communication module 350 may transmit or receive a command and/or data with the hub 500 according to the control of the processing circuit 310. The communication module 350 may be, for example, a wireless transceiver, and may communicate with the hub 500 through the above-described accessible interface.

The third IoT device 400 may include a processing circuit 410, a secure module 427, a memory 430, and a communication module 450. The processing circuit 410 may control the secure module 427, the memory 430 and the communication module 450. The processing circuit 410 may be, for example, an IC, a processor, or a CPU. The processing circuit 410 may transmit or receive a command and/or data for pairing with the hub 500 through the communication module 450. The secure module 427 may be, for example, a hardware secure module and may convert data that has been processed or that is to be processed by the processing circuit 410 into secure data (e.g., encrypted data). The secure module 427 may also convert data that has been processed or that is to be processed by the communication module 450 into secure data (e.g., encrypted data).

For example, when the third IoT device 400 includes at least one sensor, the processing circuit 410 may process a signal detected by the sensor and may transmit the processed signal to the hub 500 through the communication module 450. At this time, the secure module 427 may convert data to be transmitted to the communication module 450 into secure data.

The memory 430 may store data that has been processed or that is to be processed by the processing circuit 410 or the communication module 450. The communication module 450 may transmit or receive a command and/or data with the hub 500 according to the control of the processing circuit 410. The communication module 450 may be, for example, a wireless transceiver, and may communicate with the hub 500 through the above-described accessible interface.

The hub 500 may include a processing circuit 510, a secure module 527, a memory 530, and a communication module 550 (e.g., a wireless or wired transceiver). Herein, the terms processing circuit, processor, and processing module may be used interchangeably. The processing circuit 510 may control the secure module 527, the memory 530, and the communication module 550. The processing circuit 510 may be, for example, an IC, a processor, or a CPU. The processing circuit 510 may transmit or receive a command and/or data for pairing with each of the IoT devices 200, 300, and 400 through the communication module 550. The secure module 527 may be, for example, a hardware secure module, and may convert data that has been processed or that is to be processed by the processing circuit 510 into secure data (e.g., encrypted data). The secure module 527 may also convert data that has been processed or that is to be processed by the communication module 550 into secure data (e.g., encrypted data).

The secure module 527 may store authentication information 527-1 as the secure data. The authentication information 527-1 may include, for example, pairing information with respect to each of the IoT devices 200, 300, and 400.

The memory 530 may store data that has been processed or that is to be processed by the processing circuit 510 or the communication module 550. The memory 530 may include, for example, an analysis database (DB) 530-1 which stores analyzed data output from the processing circuit 510. The analysis DB 530-1 may refer to a data storage region.

Each of the memories 230, 330, 430, and 530 may be, for example, a volatile or a non-volatile memory. According to exemplary embodiments, the memories 230, 330, 430, and 530 may be embedded in or may be removable from the devices 200, 300, 400, and 500, respectively. Each of the memories 230, 330, 430, and 530 may be implemented as, for example, a hard disk drive (HDD), a solid state drive (SSD), a universal flash storage (UFS), or an embedded multimedia card (eMMC). However, exemplary embodiments of the inventive concept are not limited thereto.

The communication module 550 may transmit or receive a command and/or data with the each of the IoT devices 200, 300, and 400 according to the control of the processing circuit 510. The communication module 550 may be, for example, a wireless transceiver, and may communicate with the IoT devices 200, 300, and 400 through the above-described accessible interface.

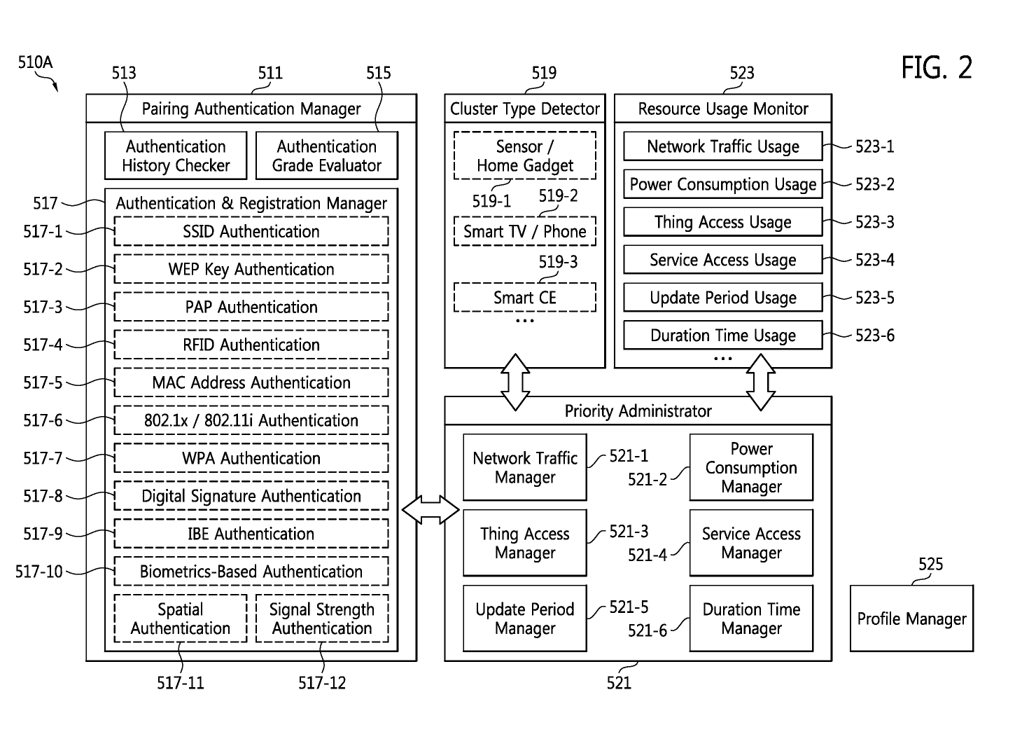

FIG. 2 is a block diagram of a processing module 510A for controlling an access right to a resource using a pairing technique used with respect to an IoT device according to exemplary embodiments of the inventive concept.

Referring to FIGS. 1 and 2, the hub 500 may receive a pairing request output from the IoT device 200, 300, or 400, may select one of predetermined pairing authentication techniques (e.g., methods) based on the pairing request, and may perform pairing with the IoT device 200, 300, or 400 using the selected authentication technique. The hub 500 may give the IoT device 200, 300, or 400 a right to access a resource, and/or the hub 500 may determine that the IoT devices 200, 300, or 400 have a right to access a resource. At this time, the given access right may be uniquely determined according to the authentication technique selected by the hub 500.

For example, when the hub 500 and the first IoT device 200 are paired using a first pairing authentication technique among the predetermined pairing authentication techniques, the hub 500 may give the first IoT device 200 a first access right to a resource. When the hub 500 and the second IoT device 300 are paired using a second pairing authentication technique among the predetermined pairing authentication techniques, the hub 500 may give the second IoT device 300 a second access right to a resource. When the hub 500 and the third IoT device 400 are paired using a third pairing authentication technique among the predetermined pairing authentication techniques, the hub 500 may give the third IoT device 400 a third access right to a resource. According to exemplary embodiments, the first through third access rights may be different from one another.

The processing module 510A may include a pairing authentication manager 511, a cluster type detector (also referred to as a cluster type determiner) 519, a priority administrator (also referred to as an access right determiner) 521, a resource usage monitor 523, and a profile manager 525. The components included in the processing module 510A (e.g., the pairing authentication manager 511, the authentication history checker 513, the authentication grade evaluator 515, the authentication and registration manager 517, etc.), may be implemented using a variety of hardware and/or software components, circuits, etc.

In exemplary embodiments, each element 511, 519, 521, 523, and 525 may be implemented as hardware components (e.g., circuits). In exemplary embodiments, each element 511, 519, 521, 523, and 525 may be implemented as software components executed by the processing circuit 510. In exemplary embodiments, some of the elements 511, 519, 521, 523, and 525 may be implemented as hardware components and the others may be implemented as software components.

Consequently, according to exemplary embodiments, the processing module 510A may be formed of hardware components only, software components only, or a combination of hardware components and software components according.

The pairing authentication manager 511 controls or manages pairing with each of the IoT devices 200, 300, and 400. For example, the pairing authentication manager 511 may check authentication history in response to a pairing request output from each of the IoT devices 200, 300, and 400, may perform authentication using a pairing authentication technique appropriate for each IoT device 200, 300, and 400 when there is no authentication history, may evaluate an authentication grade of the IoT device 200, 300, and 400 based on the authentication result, and may control or manage the storing of the authentication result and/or the authentication grade. For example, the authentication result and/or the authentication grade may be stored in the secure module 527 or a secure region of the memory 530. However, exemplary embodiments of the inventive concept are not limited thereto.

The pairing authentication manager 511 may include an authentication history checker (an authentication history checking circuit) 513, an authentication grade evaluator (an authentication grade evaluating circuit) 515, and an authentication and registration manager (an authentication and registration managing circuit) 517.

The authentication history checker 513 may check the access history and/or authentication information of the IoT device 200, 300, or 400 that requests access or pairing. For example, the authentication history checker 513 may check the access history and/or authentication information of the IoT device 200, 300, or 400 using the authentication information 527-1 stored in the secure module 527 and may generate a confirmation signal.

The authentication and registration manager 517 may perform an authentication process and storing process of authentication information with respect to the IoT device 200, 300, or 400 that has requested access or pairing in response to the confirmation signal.

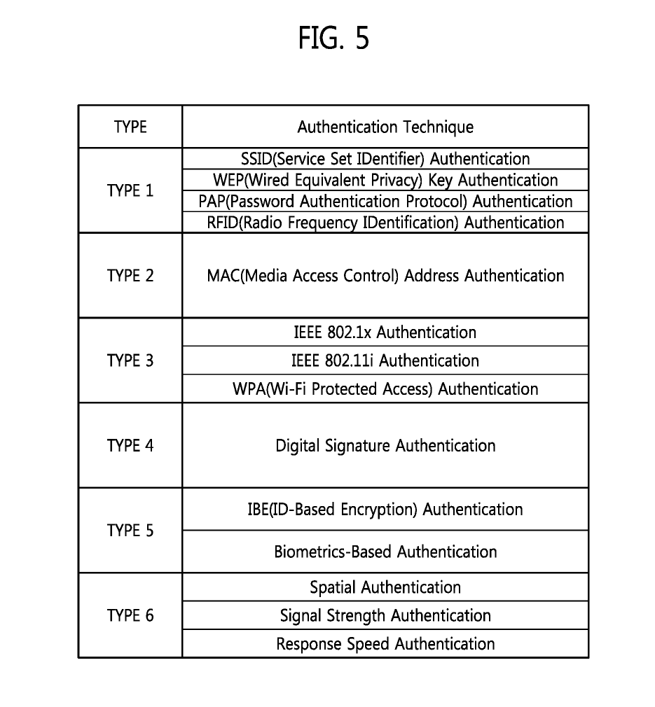

FIG. 5 is a diagram of pairing authentication techniques used in the processing module 510A illustrated in FIG. 2 according to exemplary embodiments of the inventive concept. Referring to FIGS. 2 and 5, many types (e.g., TYPE1 through TYPE6) of predetermined pairing authentication techniques may be utilized, as shown in FIG. 5. Information regarding the predetermined pairing authentication techniques may be stored in the secure module 527 or a secure region of the memory 530. However, exemplary embodiments of the inventive concept are not limited thereto.

The first type TYPE1 may be an identifier/password-based authentication technique, but is not limited thereto. The second type TYPE2 may include, for example, a service set identifier (SSID) authentication technique 517-1, a wired equivalent privacy (WEP) key authentication technique 517-2, a password authentication protocol (PAP) authentication technique 517-3, and an RFID authentication technique 517-4. However, the first type TYPE1 is not limited thereto. The second type TYPE2 may be a media access control (MAC) address-based authentication technique 517-5, but is not limited thereto. The third type TYPE3 may be a code (or encryption) protocol-based authentication technique and may include, for example, an IEEE 802.1x/802.11i authentication technique 517-6, a Wi-Fi protected access (WPA) authentication technique 517-7, and a Wi-Fi protected access II (WPA2) authentication technique. However, the third type TYPE3 is not limited thereto.

The fourth type TYPE4 may be a certificate-based authentication technique including, for example, a digital signature authentication technique 517-8, but is not limited thereto. The fifth type TYPE5 may include, for example, an ID-based encryption (IBE)-based authentication technique 517-9 and a biometric-based authentication technique 517-10, but is not limited thereto.

The sixth type TYPE6 may include a spatial authentication technique 517-11, a signal strength authentication technique 517-12, and a response speed authentication technique, but is not limited thereto.

The authentication and registration manager 517 may select one of the pairing authentication techniques 517-1 through 517-12 using an authentication request signal included in a pairing request output from the IoT device 200, 300, or 400, and may store authentication information related to the selected authentication technique in the secure module 527 or the secure region of the memory 530. However, exemplary embodiments of the inventive concept are not limited thereto.

The authentication request signal may include, for example, one of an ID, a password, a MAC address, a WPA-related signal, a WPA2-related signal, a digital signature, an IBE-related signal, and a biometrics-related signal. However the authentication request signal is not limited thereto.

The authentication request signal may include, for example, the signal strength of the IoT device 200, 300, or 400, position (or location) information of the IoT device 200, 300, or 400, or a response speed of the IoT device 200, 300, or 400. The position information of the IoT device 200, 300, or 400 may be generated, for example, based on satellite signals received by a global positioning system (GPS) receiver included in the IoT device 200, 300, or 400. The response speed may be calculated by the hub 500 based on a response signal output from the IoT device 200, 300, or 400 after the hub 500 outputs a particular signal to the IoT device 200, 300, or 400.

According to exemplary embodiments, the authentication and registration manager 517 may select one of the pairing authentication techniques 517-1 through 517-12 based on the signal strength, position information or response speed of the IoT device 200, 300, or 400.

According to exemplary embodiments, the authentication and registration manager 517 may identify the IoT device 200, 300, or 400 using the signal strength of the IoT device 200, 300, or 400.

According to exemplary embodiments, the authentication grade evaluator 515 may evaluate the authentication grade of the IoT device 200, 300, or 400 using the authentication technique selected by the authentication and registration manager 517. For example, the authentication grade evaluator 515 may evaluate the authentication grade of the first IoT device 200 as a first grade, the authentication grade of the second IoT device 300 as a second grade higher than the first grade, and the authentication grade of the third IoT device 400 as a third grade higher than the second grade. However, exemplary embodiments of the inventive concept are not limited thereto.

The authentication grade evaluator 515 may store the evaluated grade of the IoT device 200, 300, or 400 in the secure module 527 or the secure region of the memory 530. However, exemplary embodiments of the inventive concept are not limited thereto.

The cluster type detector 519 may receive and analyze data from the IoT device 200, 300, or 400 paired with the hub 500, and may determine a cluster type of the IoT device 200, 300, or 400 as one of a plurality of cluster types according to the analysis result. The cluster type determined for the IoT device 200, 300, or 400 may be stored in the secure module 527 or the secure region of the memory 530. However, exemplary embodiments of the inventive concept are not limited thereto.

For example, the cluster type detector 519 may classify IoT devices corresponding to a sensor or a home gadget as a first cluster type 519-1, IoT devices corresponding to a smart TV or a smartphone as a second cluster type 519-2, and IoT devices corresponding to smart appliances as a third cluster type 519-3. The different cluster types correspond to different types of IoT devices. The IoT devices may be classified as cluster types based on data received by the hub 500 from the IoT devices.

The priority administrator 521 may determine an access right to a resource to which the IoT device 200, 300, or 400 can access using at least one of the authentication grade evaluated by the authentication grade evaluator 515 for the IoT device 200, 300, or 400 and the cluster type determined by the cluster type detector 519 for the IoT device 200, 300, or 400.

For example, the cluster type detector 519 may classify IoT devices gathering similar information as the same cluster type, and therefore, the priority administrator 521 may give similar access rights or policies to the IoT devices classified as the same cluster type. Each cluster type may correspond to IoT devices that gather different types of information. For example, a first cluster type may correspond to IoT devices that gather first information, and the second cluster type may correspond to IoT devices that gather second information different from the first information.

The resource may include at least one among a bandwidth of a channel formed between the hub 500 and the IoT device 200, 300, or 400, an amount of power of the hub 500 consumed by the IoT device 200, 300, or 400, at least one hardware component included in the hub 500, at least one software component included in the hub 500, another IoT device paired with the hub 500, an update period of data transmitted from the IoT device 200, 300, or 400, and a pairing duration time between the hub 500 and the IoT device 200, 300, or 400.

The priority administrator 521 may include a network traffic manager 521-1, a power consumption manager 521-2, a thing access manager 521-3, a service access manager 521-4, an update period manager 521-5, and a duration time manager 521-6. However, exemplary embodiments of the inventive concept are not limited thereto.

The priority administrator 521 may manage or control an access right to the resource by IoT devices and/or cluster types using resource budget history information stored in the analysis DB 530-1 of the memory 530.

The network traffic manager 521-1 may determine (or estimate) the bandwidth budget of a channel for each IoT device and/or each cluster type using the resource budget history information stored in the analysis DB 530-1 of the memory 530, and may manage or control the bandwidth according to the determination result.

The power consumption manager 521-2 may determine (or estimate) a power consumption budget for each IoT device and/or each cluster type using the resource budget history information stored in the analysis DB 530-1 of the memory 530, and may manage or control power consumption according to the determination result.

The thing access manager 521-3 may determine (or estimate) access or no-access (e.g., determine whether to grant access) to another IoT device, at least one hardware component, and/or at least one software component for each IoT device and/or each cluster type using the resource budget history information stored in the analysis DB 530-1 of the memory 530, and may manage or control the access according to the determination result.

The service access manager 521-4 may determine (or estimate) access or no-access (e.g., determine whether to grant access) to a service for each IoT device and/or each cluster type using the resource budget history information stored in the analysis DB 530-1 of the memory 530, and may manage or control the access according to the determination result.

The update period manager 521-5 may determine (or estimate) the update period of data output or related to an IoT device for each IoT device and/or each cluster type using the resource budget history information stored in the analysis DB 530-1 of the memory 530, and may manage or control the access according to the determination result.

The duration time manager 521-6 may determine (or estimate) a pairing duration time between an IoT device and the hub 500 for each IoT device and/or each cluster type using the resource budget history information stored in the analysis DB 530-1 of the memory 530, and may manage or control the access according to the determination result.

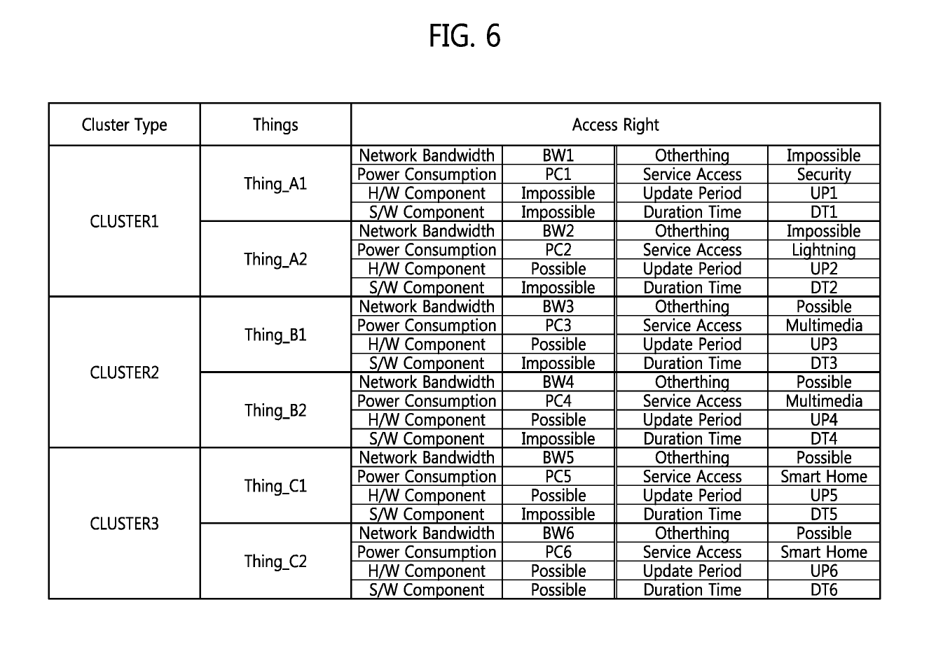

FIG. 6 is a diagram showing access rights to resources defined for each cluster type and/or each device. Referring to FIGS. 1 through 6, it is assumed that the cluster type detector 519 assigns things Thing_A1 and Thing_A2 to a first cluster type CLUSTER1, things Thing_B1 and Thing_B2 to a second cluster type CLUSTER2, and things Thing_C1 and Thing_C2 to a third cluster type CLUSTER3.

It is also assumed that the first IoT device 200 collectively represents the things Thing_A1 and Thing_A2, the second IoT device 300 collectively represents the things Thing_B1 and Thing_B2, and the third IoT device 400 collectively represents the things Thing_C1 and Thing_C2.

For example, for the thing Thing_A1 assigned to the first cluster type CLUSTER1, the network traffic manager 521-1 may assign (or determine) a network bandwidth of BW1 as the access right, the power consumption manager 521-2 may assign a power consumption of PC1 as the access right, the thing access manager 521-3 may assign a status of “impossible access” to another IoT device, at least one hardware component, and at least one software component as the access right, the service access manager 521-4 may assign a status of “application to security” as the access right, the update period manager 521-5 may assign an update period of UP1 as the access right, and the duration time manager 521-6 may assign a duration time of DT1 as the access right.

For the thing Thing_A2 assigned to the first cluster type CLUSTER1, the network traffic manager 521-1 may assign a network bandwidth of BW2 as the access right, the power consumption manager 521-2 may assign a power consumption of PC2 as the access right, the thing access manager 521-3 may assign a status of possible access only to at least one hardware component as the access right, the service access manager 521-4 may assign a status of “application to lighting” as the access right, the update period manager 521-5 may assign an update period of UP2 as the access right, and the duration time manager 521-6 may assign a duration time of DT2 as the access right.

For example, for the thing Thing_C2 assigned to the third cluster type CLUSTER3, the network traffic manager 521-1 may assign a network bandwidth of BW6 as the access right, the power consumption manager 521-2 may assign a power consumption of PC6 as the access right, the thing access manager 521-3 may assign a status of “possible access” to another IoT device, at least one hardware component, and at least one software component as the access right, the service access manager 521-4 may assign a status of “application to smart home” as the access right, the update period manager 521-5 may assign an update period of UP6 as the access right, and the duration time manager 521-6 may assign a duration time of DT6 as the access right.

The resource usage monitor 523 may monitor the usage of a resource used by the IoT device 200, 300, or 400 and may send a monitoring signal to the priority administrator 521. In response to the monitoring signal, the priority administrator 521 may adjust (e.g., increase, maintain, or decrease) the access right to the resource determined (or assigned) for the IoT device 200, 300, or 400 in real-time. The resource usage monitor 523 may include a network traffic usage monitor 523-1, a power consumption usage monitor 523-2, a thing access usage monitor 523-3, a service access usage monitor 523-4, an update period usage monitor 523-5, and a duration time usage monitor 523-6. However, exemplary embodiments of the inventive concept are not limited thereto.

The network traffic usage monitor 523-1 may monitor the bandwidth of a channel (or network traffic) for each IoT device and/or each cluster type, and may send a first monitoring signal to the priority administrator 521. The network traffic manager 521-1 may control the channel's bandwidth (or the network traffic) in real-time in response to the first monitoring signal.

The power consumption usage monitor 523-2 may monitor power consumption for each IoT device and/or each cluster type, and may send a second monitoring signal to the priority administrator 521. The power consumption manager 521-2 may control the power consumption in real-time in response to the second monitoring signal.

The thing access usage monitor 523-3 may monitor access or no-access (e.g., monitor whether access is granted) to another IoT device, at least one hardware component, and/or at least one software component for each IoT device and/or each cluster type, and may send a third monitoring signal to the priority administrator 521. The thing access manager 521-3 may control access or no-access (e.g., control whether access is granted) to another IoT device, at least one hardware component, and/or at least one software component in real-time in response to the third monitoring signal.

The service access usage monitor 523-4 may monitor access or no-access (e.g., monitor whether access is granted) to a service for each IoT device and/or each cluster type, and may send a fourth monitoring signal to the priority administrator 521. The service access manager 521-4 may control access or no-access (e.g., control whether access is granted) to the service in real-time in response to the fourth monitoring signal.

The update period usage monitor 523-5 may monitor an update period of data output from or related to an IoT device for each IoT device and/or each cluster type, and may send a fifth monitoring signal to the priority administrator 521. The update period manager 521-5 may control the update period in real-time in response to the fifth monitoring signal.

The duration time usage monitor 523-6 may monitor a pairing duration time between an IoT device and the hub 500 for each IoT device and/or each cluster type, and may send a sixth monitoring signal to the priority administrator 521. The duration time manager 521-6 may control the pairing duration time in real-time in response to the sixth monitoring signal.

The profile manager 525 may manage or control the authentication information 527-1 and/or the analysis DB 530-1.

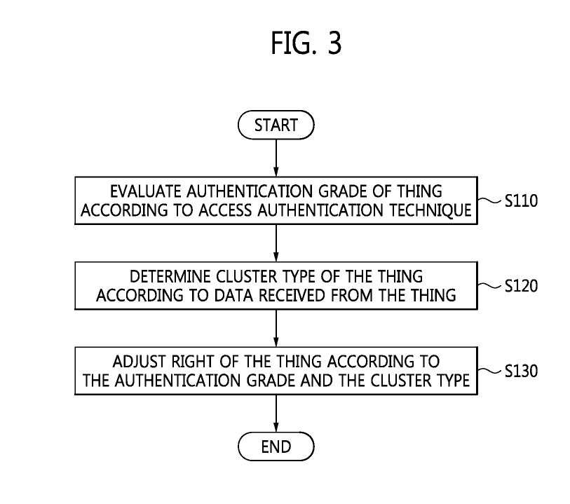

FIG. 3 is a schematic flowchart of the operation of the processing module 510A illustrated in FIG. 2 according to an exemplary embodiment of the inventive concept. Referring to FIGS. 1 through 3, the processing circuit 510 of the hub 500 may evaluate the authentication grade of the IoT device 200, 300, or 400 according to an access authentication technique used for the IoT device 200, 300, or 400 in operation S110. The evaluation of the authentication grade may refer to direct or physical evaluation of the IoT device 200, 300, or 400.

The processing circuit 510 of the hub 500 may analyze data received from the IoT device 200, 300, or 400 and may assign (or determine) one of a plurality of cluster types to the IoT device 200, 300, or 400 according to the analysis result in operation S120. The determination of a cluster type may refer to indirect or signal analysis evaluation of the IoT device 200, 300, or 400.

The processing circuit 510 of the hub 500 may control an access right to a resource which can be accessed by the IoT device 200, 300, or 400 according to the evaluated authentication grade and/or the determined cluster type in operation S130.

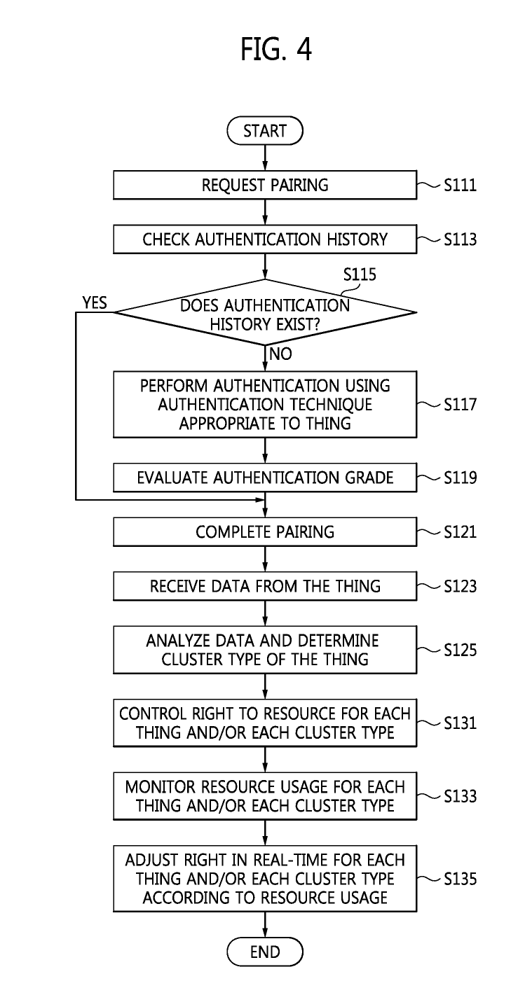

FIG. 4 is a detailed flowchart of the operation of the processing module 510A illustrated in FIG. 2 according to an exemplary embodiment of the inventive concept. Referring to FIGS. 1 through 4, the processing circuit 510 of the hub 500 may receive a pairing request from the IoT device 200, 300, or 400 through the communication module 550 in operation S111.

The authentication history checker 513 of the processing circuit 510 may check an authentication history of the IoT device 200, 300, or 400 in response to the pairing request or an authentication request signal included in the pairing request in operation S113.

When authentication information regarding the IoT device 200, 300, or 400 exists (in case of YES) in operation S115, the authentication history checker 513 may inform the IoT device 200, 300, or 400 of the completion of pairing in operation 5121. However, when authentication information regarding the IoT device 200, 300, or 400 does not exist (in case of NO) in operation S115, the authentication history checker 513 may send the authentication and registration manager 517 an indication signal indicating that the authentication signal does not exist, and may send the authentication request signal included in the pairing request. In exemplary embodiments, when authentication information regarding the IoT device 200, 300, or 400 does not exist (in case of NO) in operation S115, the authentication history checker 513 may send only the authentication request signal included in the pairing request to the authentication and registration manager 517.

The authentication and registration manager 517 may select one of predetermined pairing authentication techniques in response to the indication signal and the authentication request signal (or in response to just the authentication request signal), may perform authentication on the IoT device 200, 300, or 400 using the selected authentication technique, and may generate authentication information corresponding to the authentication result in operation S117.

The authentication grade evaluator 515 may evaluate the authentication grade of the IoT device 200, 300, or 400 using the authentication information generated by the authentication and registration manager 517 in operation S119. For example, the authentication information corresponding to the selected authentication technique may be used as an index for evaluating the authentication grade.

After evaluation of the authentication grade is completed, the authentication history checker 513 may inform the IoT device 200, 300, or 400 of the completion of pairing in operation S121.

The cluster type detector 519 in the processing circuit 510 of the hub 500 may receive data from the IoT device 200, 300, or 400 through the communication module 550 in operation S123. The cluster type detector 519 may analyze the received data and determine one of the cluster types as the cluster type of the IoT device 200, 300, or 400 according to the analysis result in operation S125.

The priority administrator 521 may control the access right to resources which the IoT device 200, 300, or 400 can access using at least one of the authentication grade evaluated by the authentication grade evaluator 515 and the cluster type determined by the cluster type detector 519 in operation S131.

The resource usage monitor 523 may monitor the usage of a resource used by the IoT device 200, 300, or 400 for each IoT device 200, 300, or 400 and/or each cluster type, and may output a monitoring signal to the priority administrator 521 in operation S133.

The priority administrator 521 may adjust (e.g., increase, maintain, or decrease) the access right to the resource in real-time (or on-the fly) for each IoT device 200, 300, or 400 and/or each cluster type based on the monitoring signal in operation S135.

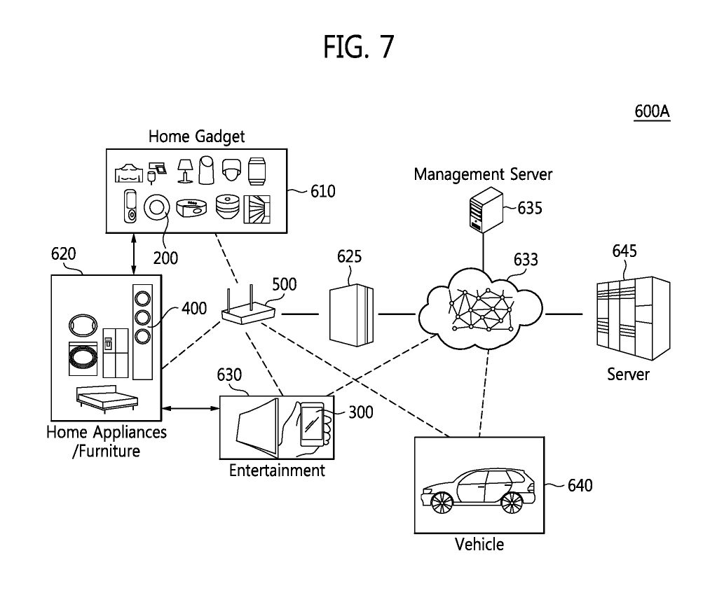

FIG. 7 is a block diagram of a data processing system 600A including the hub 500 illustrated in FIG. 1 according to exemplary embodiments of the inventive concept. Referring to FIGS. 1 through 7, the data processing system 600A may include the hub 500 and IoT devices 610, 620, 630, and 640.

It is assumed that the structure of the IoT devices 610 is the same as or similar to that of the first IoT device 200, the structure of the IoT devices 630 is the same as or similar to that of the second IoT device 300, and the structure of the IoT devices 620 and 640 is the same as or similar to that of the third IoT device 400.

An IoT or the data processing system 600A may refer to a network including IoT devices that use wired and/or wireless communication. Accordingly, an IoT here may be referred to as an IoT network system, a ubiquitous sensor network (USN) communication system, a machine type communication (MTC) system, a machine-oriented communication (MOC) system, a machine-to-machine (M2M) communication system, or a device-to-device (D2D) communication system.

Here, an IoT network system may include elements such as, for example, an IoT device, the hub 500, an access point, a gateway, a communication network, and/or a server. However, it is to be understood that these elements are defined to describe the IoT network system, and the scope of the IoT network system is not limited to these elements.

The IoT network system may use, for example, a user datagram protocol (UDP), a transmission protocol such as a transmission control protocol (TCP), an IPv6 low-power wireless personal area networks (6LoWPAN) protocol, An IPv6 Internet routing protocol, a constrained application protocol (CoAP), a hypertext transfer protocol (HTTP), a message queue telemetry transport (MQTT), or an MQTT for sensors networks (MQTT-S) for exchange (or communication) of information among at least two elements therein. However, exemplary embodiments of the inventive concept are not limited thereto.

When the IoT network system is implemented as a wireless sensor network (WSN), each of the IoT devices 200, 300, 400, 610, 620, 630, and 640 may be used as a sink node or a sensor node. The sink node is also called a base station and functions as a gateway connecting the WSN with an external network (e.g., the Internet). The sink node may assign a task to the sensor node and gather events sensed by the sensor node. The sensor node is a node within the WSN, may process and gather sensory information, and may communicate with other nodes in the WSN.

The IoT devices 200, 300, 400, 610, 620, 630, and 640 may include an active IoT device which operates using its own power and a passive IoT device which operates using wireless power transferred from an outside source. The active IoT device may include, for example, a refrigerator, an air conditioner, a telephone, or an automobile. The passive IoT device may include, for example, an RFID tag or an NFC tag. However, when an RFID tag or an NFC tag includes a battery, the RFID or NFC tag may be classified as an active IoT device.

The IoT devices 200, 300, 400, 610, 620, 630, and 640 may include a passive communication interface such as, for example, a two-dimensional barcode, a three-dimensional barcode, a QR code, an RFID tag, or an NFC tag. The IoT devices 200, 300, 400, 610, 620, 630, and 640 may also include an active communication interface such as, for example, a modem or a transceiver.

At least one of the IoT devices 200, 300, 400, 610, 620, 630, and 640 may transmit and receive control information and/or data through a wired or wireless communication interface. The wired or wireless communication interface may be an example of an accessible interface.

The hub 500 in the IoT network system 600A may function as an access point. The IoT devices 200, 300, 400, 610, 620, 630, and 640 may be connected to a communication network or other IoT devices through the hub 500.

Although the hub 500 is shown as an independent device in FIG. 7, in exemplary embodiments, the hub 500 may be embedded in one of the IoT devices 400, 610, 620, 630, and 640. For example, the hub 500 may be embedded in a television (TV or a smart TV) or a smart refrigerator. A user may be allowed to monitor or control at least one of the IoT devices 400, 610, 620, 630, and 640 connected to the hub 500 through a display of the TV or the smart refrigerator.

The hub 500 may be one of the IoT devices 610, 620, 630, and 640. For example, a smartphone may be an IoT device functioning as the hub 500. The smartphone may perform tethering.

The IoT network system 600A may also include a gateway 625. The gateway 625 may connect the hub 500, which functions as an access point, to an external communication network (e.g., the Internet or a public switched network). Each of the IoT devices 200, 300, 400, 610, 620, 630, and 640 may be connected to an external communication network through the gateway 625. In exemplary embodiments, the hub 500 and the gateway 625 may be implemented in a single device. Alternatively, the hub 500 may function as a first gateway and the gateway 625 may function as a second gateway.

One of the IoT devices 200, 300, 400, 610, 620, 630, and 640 may function as the gateway 625. For example, a smartphone may be both an IoT device and the gateway 625. The smartphone may be connected to a mobile cellular network.

The IoT network system 600A may also include a at least one communication network 633. The communication network 633 may include, for example, the Internet and/or a public switched network. However, exemplary embodiments of the inventive concept are not limited thereto. The public switched network may include, for example, a mobile cellular network. The communication network 633 may be, for example, a communication channel which transfers information gathered by the IoT devices 610, 620, 630, and 640.

The IoT network system 600A may also include a management server 635 and/or a server 645 connected to the communication network 633. The communication network 633 may transmit a signal (or data) detected by at least one of the IoT devices 610, 620, 630, and 640 to the management server 635 and/or the server 645.

The management server 635 and/or the server 645 may store or analyze a signal received from the communication network 633.

The management server 635 and/or the server 645 may transmit the analysis result to at least one of the IoT devices 610, 620, 630, and 640 via the communication network 633. The management server 635 may manage the states of the hub 500, the gateway 625, the communication network 633, and/or each of the IoT devices 610, 620, 630, and 640.

The server 645 may receive and store data related to at least one of the IoT devices 610, 620, 630, and 640, and may analyze the stored data. The server 645 may transmit the analysis result to at least one of the IoT devices 610, 620, 630, and 640 or to a device (e.g., a smartphone) possessed by a user via the communication network 633.

For example, in an exemplary embodiment, when one of the IoT devices 610, 620, 630, and 640 is a blood glucose monitoring IoT device which measures a user's blood glucose, the server 645, which stores a blood glucose limit preset by the user, may receive a measured blood glucose level from the glucose monitoring IoT device via the communication network 633. At this time, the server 645 may compare the blood glucose limit with the measured blood glucose level, and may transmit a warning signal to at least one of the IoT devices 610, 620, 630, and 640 or a user device via the communication network 633 when the measured blood glucose level is higher than the blood glucose limit.

The IoT devices 610, 620, 630, and 640 illustrated in FIG. 7 may be classified into groups according to their characteristics. For example, IoT devices may be classified into the home gadget group 610, the home appliances/furniture group 620, the entertainment group 630, or the vehicle group 640.

The home gadget group 610 may include, for example, a heart rate sensor patch, a medical tool for measuring blood glucose, lighting equipment, a hygrometer, a surveillance camera, a smartwatch, a security keypad, a temperature controller, an aroma diffuser, a window blind, etc. However, exemplary embodiments of the inventive concept are not limited to these examples.

The home appliances/furniture group 620 may include, for example, a robot vacuum cleaner, a washing machine, a refrigerator, an air conditioner, a TV, furniture (e.g., a bed including a sensor), etc. However, exemplary embodiments of the inventive concept are not limited to these examples. The entertainment group 630 may include, for example, a TV, a smart TV, a smartphone, a multimedia video system, etc. However, exemplary embodiments of the inventive concept are not limited to these examples.

The IoT devices 610, 620, 630, and 640 may also be divided into, for example, a temperature control group which controls indoor temperature, a large appliances group and a small appliances group according to power consumption, a cleanness group which controls indoor cleanness (e.g., air purifying and floor cleaning), a lighting group which controls indoor lights, and an entertainment group which controls entertainment equipment (such as TV and audio systems). The temperature control group may include, for example, an air conditioner, a power window, and an electric curtain, etc.

Each of the IoT devices 610, 620, 630, and 640 may belong to at least one group. For example, an air conditioner may belong to both the home appliances/furniture group 620 and the temperature control group. A TV may belong to both the home appliances/furniture group 620 and the entertainment group 630. The smartphone 300 may belong to both the home gadget group 610 and the entertainment group 630.

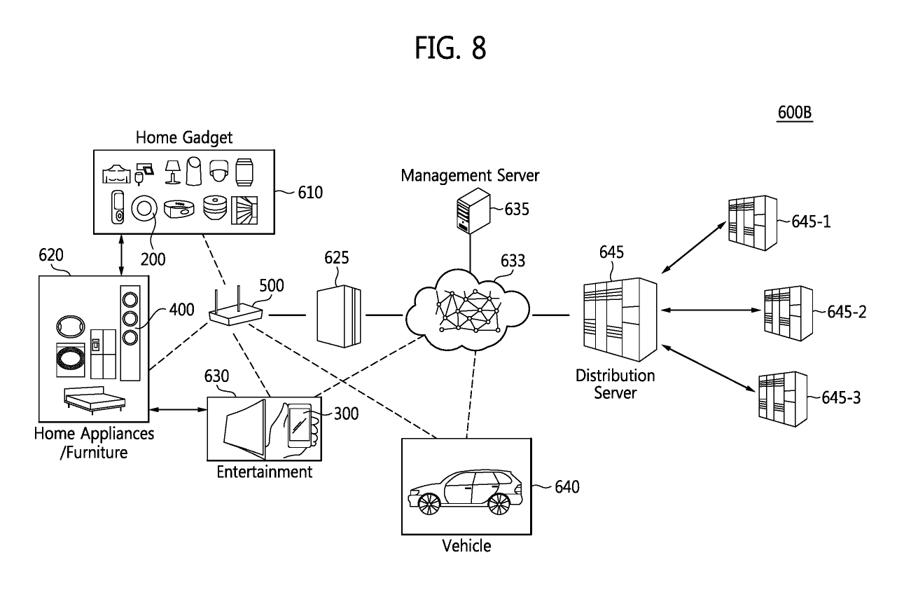

FIG. 8 is a block diagram of a data processing system 600B including the hub 500 illustrated in FIG. 1 according to exemplary embodiments of the inventive concept. Referring to FIGS. 1 through 8, the IoT network system 600B may include a hub 500, a smartphone 300, IoT devices 610, 620, 630, and 640, a gateway 625, a communication network 633, a management server 635, a distribution server 645, and a plurality of servers 645-1, 645-2, and 645-3.

Apart from the distribution server 645 and the servers 645-1, 645-2, and 645-3, the IoT network system 600B illustrated in FIG. 8 is the same as or similar to the IoT network system 600A illustrated in FIG. 7.

The distribution server 645 is connected with the servers 645-1, 645-2, and 645-3 and may distribute jobs to the servers 645-1, 645-2, and 645-3. The distribution server 645 may analyze a request transmitted from the communication network 633 through scheduling, may predict the amount of data and workload related with a job based on the analysis result, and may communicate with at least one of the servers 645-1, 645-2, and 645-3. The distribution server 645 may receive and analyze state information from the servers 645-1, 645-2, and 645-3 and may reflect the analysis result to the scheduling. The overall performance of the IoT network system 600B can be enhanced through the scheduling of the distribution server 645.

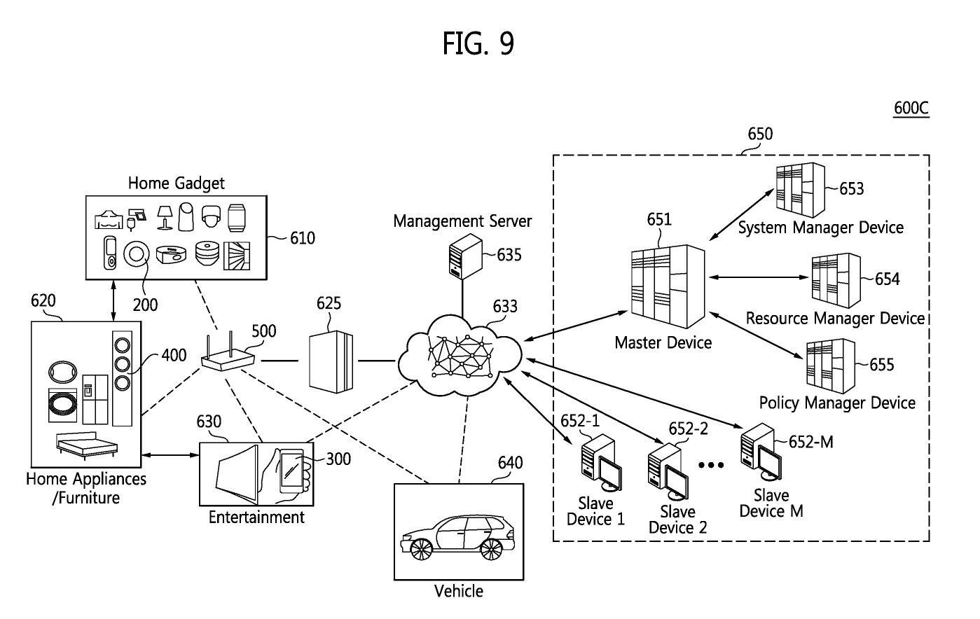

FIG. 9 is a block diagram of a data processing system 600C including the hub 500 illustrated in FIG. 1 according to exemplary embodiments of the inventive concept.

Referring to FIGS. 1 through 9, the IoT network system 600C may include a hub 500, a smartphone 300, IoT devices 610, 620, 630, and 640, a gateway 625, a communication network 633, a management server 635, and a distribution server system 650.

The distribution server system 650 may receive and store or analyze data from the communication network 633. The distribution server system 650 may send the stored data or the analyzed data to at least one of the elements 500, 625, 610, 620, 630, and 640 included in the IoT network system 600C via the communication network 633.

In exemplary embodiments, the distribution server system 650 may include a distributed computing system driven based on a distributed file system (DFS). For example, the distribution server system 650 may be driven based on at least one among various DFSs such as Hadoop DFS (HDFS), GOOGLE file system (GFS), Cloud store, Coda, NFS, and general parallel file system (GPFS). However, exemplary embodiments of the inventive concept are not limited to these examples.

In exemplary embodiments, the distribution server system 650 may include a master device 651, slave devices 652-1 through 652-M (where M is an integer greater than or equal to 3), a system manager device 653, a resource manager device 654, and a policy manager device 655.

Each of the slave devices 652-1 through 652-M may store a data block. For example, data transmitted via the communication network 633 may be divided into data blocks by the master device 651. The data blocks may be stored in the slave devices 652-1 through 652-M in a distributed fashion. For example, when the distribution server system 650 is driven based on the HDFS, each of the slave devices 652-1 through 652-M may execute, as a data node, a task tracker to store at least one data block.

The master device 651 may divide data transmitted via the communication network 633 into data blocks. The master device 651 may provide each of the data blocks for at least one of the slave devices 652-1 through 652-M. For example, when the distribution server system 650 is driven based on the HDFS, the master device 651 may execute, as a name node, a job tracker to schedule the distribution of the data blocks. The master device 651 may manage distributed storage information indicating a stored position of each of the data blocks that have been distributed. The master device 651 may process a data store request and a data read request based on the distributed storage information.

The system manager device 653 may control and manage the overall operation of the distribution server system 650. The resource manager device 654 may manage the resource usage of each of elements included in the distribution server system 650. The policy manager device 655 may manage a policy on an access to each of the IoT devices 610, 620, 630, and 640 which are accessible via the communication network 633.

The master device 651, the slave devices 652-1 through 652-M, the system manager device 653, the resource manager device 654, and the policy manager device 655 may each may include a universal computer such as a personal computer (PC) and/or a dedicated computer such as a workstation, and each may include hardware modules for implementing a unique function. The master device 651, the slave devices 652-1 through 652-M, the system manager device 653, the resource manager device 654, and the policy manager device 655 each may perform a unique function by running software or firmware using a processor core.

As shown in FIG. 9, the master device 651 and the slave devices 652-1 through 652-M may share the communication network 633 with the IoT devices 610, 620, 630, and 640, and may transmit or receive data (or a data block) with one another via the communication network 633.

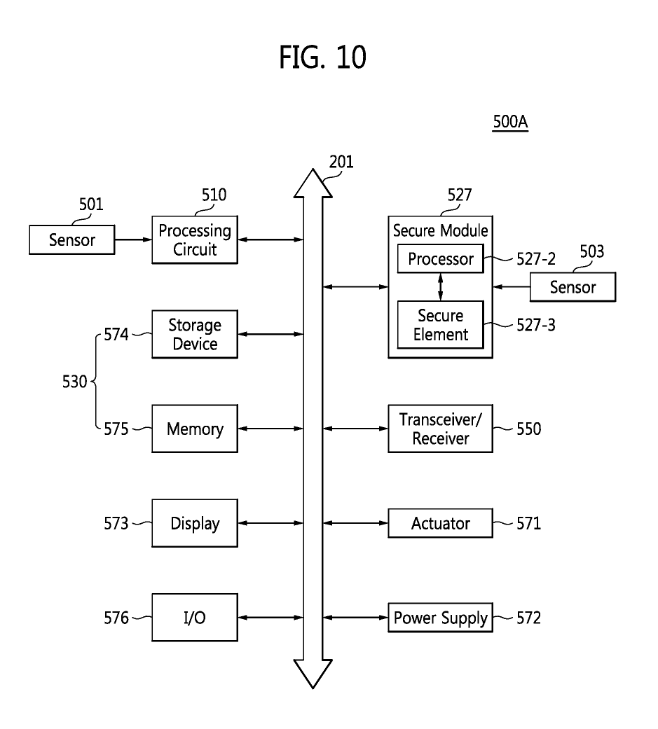

FIG. 10 is a block diagram of an example 500A of the hub 500 illustrated in FIG. 1 according to an exemplary embodiment of the inventive concept. Referring to FIGS. 1 and 10, the hub 500A may include a bus 201, a first sensor 501, a second sensor 503, a display 573, a secure module 527, a processing circuit 510, a communication module (e.g., a transceiver/receiver) 550, an actuator 571, a power supply 572, a storage device 574, a memory 575, and an input/output (I/O) device 576. The storage device 574 and the memory 575 may be collectively represented by the memory 530. The secure module 527 may be implemented as, for example, a hardware secure module, however exemplary embodiments of the inventive concept are not limited thereto.

The elements 527, 530, 550, 571, 572, 573, and 576 may transmit or receive a command and/or data with one another via the bus 201.

The first sensor 501 may transmit a detection signal to the processing circuit 510. The display 573 may display data processed by the hub 500A and/or may provide a user interface (UI) or a graphical user interface (GUI) for a user.

The processing circuit 510 may control the overall operation of the hub 500A. The processing circuit 510 may execute an application such as, for example, an Internet browser, a game, a video, etc.

The communication module 550 may perform communication as a communication interface using, for example, LAN, WLAN such as Wi-Fi, WPAN such as BLUETOOTH, wireless USB, ZIGBEE, NFC, RFID, power line communication (PLC), or a mobile cellular network. The communication module 550 may be implemented as, for example, a transceiver or a receiver.

The storage device 574 may store a boot image for booting the hub 500A. The storage device 574 may be implemented as, for example, an HDD, an SSD, an MMC, an eMMC, or a UFS.

The memory 575 may store data necessary for the operation of the hub 500A. The memory 575 may include, for example, a volatile memory and/or a non-volatile memory.

The I/O device 576 may include an input device such as, for example, a touch pad, a keypad, or an input button, etc., and an output device such as, for example, a speaker.

The second sensor 503 may be, for example, a biosensor which detects biometric information. The second sensor 503 may detect, for example, a fingerprint, iris pattern, vein pattern, heart rate, blood glucose, etc., may generate detection data corresponding to the detection result, and may provide the detection data for a processor 527-2 of the secure module 527. However, the second sensor 503 is not limited to the biosensor and may be, for example, a luminance sensor, an acoustic sensor, or an acceleration sensor.

The secure module 527 may include the processor 527-2 and a secure element 527-3. The secure module 527 may be formed, for example, in a single package, and a bus connecting the processor 527-2 and the secure element 527-3 may be formed within the package. The secure element 527-3 may have a function of defending against external attacks, and thus may be used to safely store secure data (e.g., the authentication information 527-1). The processor 527-2 may transmit or receive data with the processing circuit 510.

The secure module 527 may include a secure element 527-3. The secure module 527 and the processing circuit 510 may generate a session key through mutual authentication. The secure module 527 may encrypt data using the session key and transmit the encrypted data to the processing circuit 510. The processing circuit 510 may decrypt the encrypted data using the session key and may generate decrypted detection data. Accordingly, the security level of data transmission in the hub 500A is increased. The secure element 527-3 may be formed, for example, in a single package together with the processing circuit 510.

The processor 527-2 of the secure module 527 may encrypt detection data output from the second sensor 503 and may store the encrypted data in the secure element 527-3. The processor 527-2 may control communication between the processing circuit 510 and the secure element 527-3.

The actuator 571 may include various elements necessary for the physical driving of the hub 500A. For example, the actuator 571 may include a motor driving circuit and a motor controlled by the motor driving circuit. The power supply 572 may provide an operating voltage necessary for the operation of the hub 500A. The power supply 572 may include a battery.

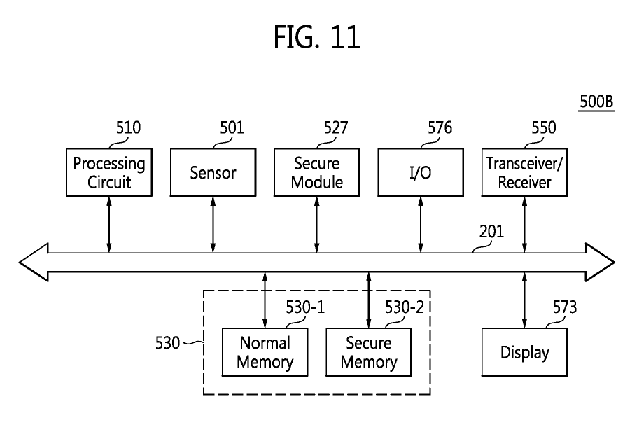

FIG. 11 is a block diagram of another example 500B of the hub 500 illustrated in FIG. 1 according to an exemplary embodiment of the inventive concept.

Referring to FIGS. 1 and 11, the hub 500B may include a first sensor 501, a display 573, a bus 201, a secure module 527, a processing circuit 510, a communication module (e.g., a transceiver/receiver) 550, an I/O device 576, and a memory 530. The memory 530 may include a normal memory 530-1 and a secure memory 530-2. According to exemplary embodiments, the analysis DB 530-1 may be implemented in the normal memory 530-1 or in the secure memory 530-2.

The elements 501, 510, 527, 530, 550, 573, and 576 may transmit or receive data with one another via the bus 201.

The processing circuit 510 may control the overall operation of the hub 500B.

The normal memory 530-1 may store data necessary for the operation of the hub 500B. The normal memory 530-1 may be formed of, for example, volatile memory or non-volatile memory which stores data that does not require security. The secure memory 530-2 may store data that requires security in the operation of the hub 500B. Although the normal memory 530-1 and the secure memory 530-2 are separated from each other in the exemplary embodiment illustrated in FIG. 11, the normal memory 530-1 and the secure memory 530-2 may be formed in a single physical memory. For example, the memory 530 including the normal memory 530-1 and the secure memory 530-2 may be removably coupled to the hub 500B.

The structure and functions of the secure module 527 illustrated in FIG. 11 may be the same as or similar to those of the secure module 527 illustrated in FIG. 10.

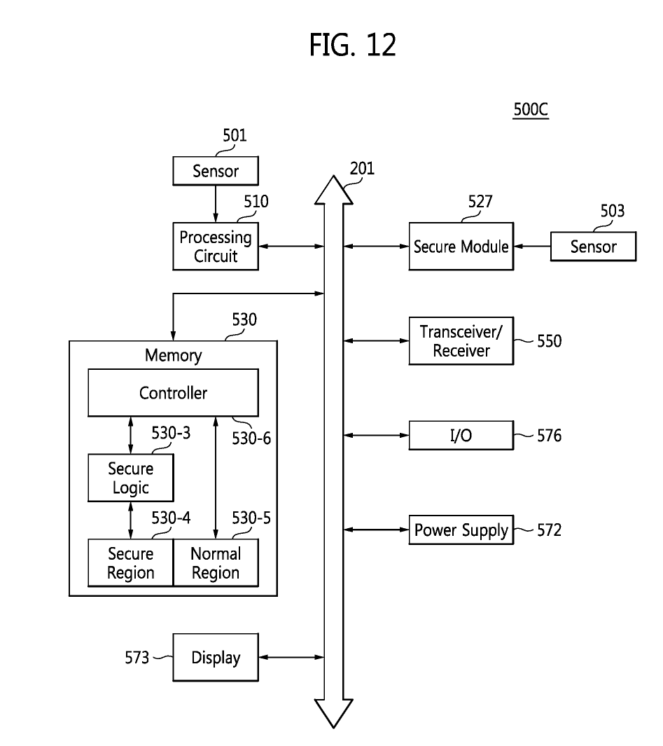

FIG. 12 is a block diagram of an example 500C of the hub 500 illustrated in FIG. 1 according to an exemplary embodiment of the inventive concept.

Referring to FIGS. 1 and 12, the hub 500C may include a first sensor 501, a second sensor 503, a display 573, a bus 201, a secure module 527, a processing circuit 510, a communication module (e.g., a transceiver/receiver) 550, a memory 530, a power supply 572, and an I/O device 576. The elements 510, 530, 573, 527, 550, 576, and 572 may transmit or receive data with one another via the bus 201.

The processing circuit 510 may control the overall operation of the hub 500C. The first sensor 501 may transmit a detection signal to the processing circuit 510. The second sensor 503 may be, for example, a biosensor which detects biometric information.

The structure and functions of the secure module 527 illustrated in FIG. 12 may be the same as or similar to those of the secure module 527 illustrated in FIG. 10.

The memory 530 may store a boot image for booting the hub 500C. The memory 530 may be implemented as, for example, flash memory, SSD, eMMC, or UFS. The memory 530 may include a secure region 530-4 and a normal region 530-5. A controller 530-6 may directly access the normal region 530-5, and may access the secure region 530-4 via a secure logic circuit 530-3. That is, the controller 530-6 may access the secure region 530-4 only via the secure logic circuit 530-3. The analysis DB 530-1 may be one of the secure region 530-4 and the normal region 530-5.

The secure module 527 may store data output from the second sensor 503 in the secure region 530-4 of the memory 530 through communication with the secure logic circuit 530-3 of the memory 530.

The power supply 572 may provide an operating voltage necessary for the operation of the hub 500C.

The I/O device 576 may include an input device such as, for example, a touch pad, a keypad, an input button, etc., and an output device such as, for example, a speaker.

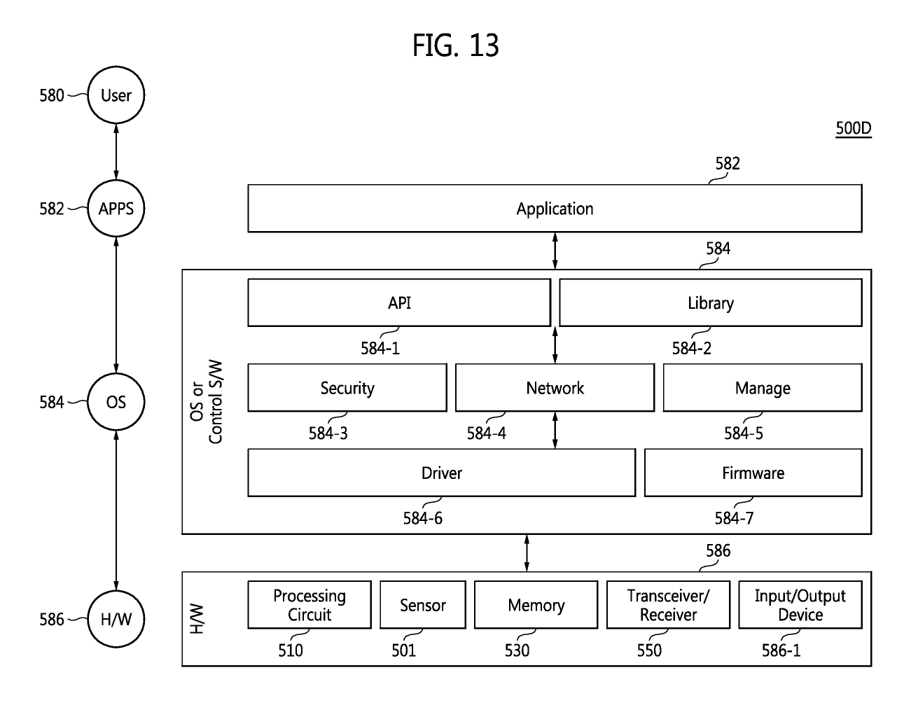

FIG. 13 is a block diagram of an example 500D of the hub 500 illustrated in FIG. 1 according to an exemplary embodiment of the inventive concept.

Referring to FIGS. 1 and 13, the hub 500D may include a processing circuit 510, a sensor 501, a communication module (e.g., a transceiver/receiver) 550, a memory 530, and an I/O device 586-1.

The hub 500D may also include an application 582 and an operating system (OS) 584. FIG. 13 shows the layers of a user 580, the application 582, the OS 584, and a hardware component 586.

The application 582 may refer to software and/or service which performs a particular function. The user 580 may refer to a subject or object using the application 582. The user 580 may communicate with the application 582 using a UI.

The application 582 may be created based on a service purpose and may interact with the user 580 through the UI corresponding to the service purpose. The application 582 may perform an operation requested by the user 580 and may call an application protocol interface (API) 584-1 and the content of a library 584-2 if necessary.

The API 584-1 and/or the library 584-2 may perform a macro operation for a particular function, or when communication with a lower layer is necessary, may provide an interface for the communication. When the application 582 requests a lower layer to operate through the API 584-1 and/or the library 584-2, the API 584-1 and/or the library 584-2 may classify the request into a security portion 584-3, a network portion 584-4, or a manage portion 584-5.

The API 584-1 and/or the library 584-2 runs a necessary layer according to the request.

For example, when the API 584-1 requests a function related with the network 584-4, the API 584-1 may transmit a parameter necessary for the network 584-4 to the network 584-4 and may call the relevant function. At this time, the network 584-4 may communicate with a relevant lower layer to perform a requested task. When there is no lower layer, the API 584-1 and/or the library 584-2 may perform the corresponding task by itself.

A driver 584-6 may manage the hardware component 586 and monitor the state of the hardware component 586. The driver 584-6 may receive a classified request from an upper layer and may deliver the request to the layer of the hardware component 586.

When the driver 584-6 requests the layer of the hardware component 586 to perform a task, firmware 584-7 may convert the request so that the layer of the hardware component 586 can accept the request. The firmware 584-7, which transmits the converted request to the hardware component 586, may be included in the driver 584-6 or executed by the hardware component 586.

The hub 500D may include the API 584-1, the driver 584-6, and the firmware 584-7, and may be equipped with an OS that manages these elements 584-1, 584-6, and 584-7. The OS may be stored in the memory 530 in a form of control command codes and data. When the hub 500D is a low-price product, the hub 500D may include control software instead of the OS since the size of the memory 530 may be small.

The hardware component 586 may execute requests (or commands) received from the driver 584-6 and/or the firmware 584-7 in order or out of order, and may store the results of executing the requests in an internal register of the hardware component 586 or in the memory 530. The results that have been stored may be returned to the driver 584-6 and/or the firmware 584-7.

The hardware component 586 may generate an interrupt to request an upper layer to perform an operation. When the interrupt is generated, the interrupt is checked in the manage portion 584-5 of the OS 584 and then processed by the hardware component 586.

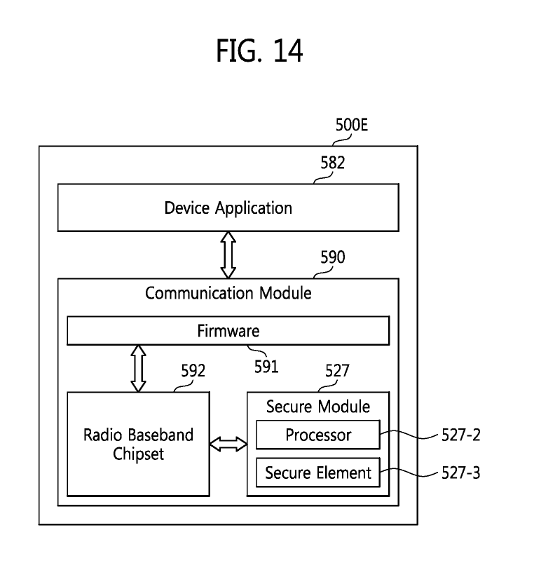

FIG. 14 is a block diagram of an example 500E of the hub 500 illustrated in FIG. 1 according to an exemplary embodiment of the inventive concept.

Referring to FIGS. 1 and 14, the hub 500E may include the device application 582 and a communication module 590. The communication module 590 may include firmware 591, a radio baseband chipset 592, and a secure module 527.

The device application 582, as a software component, may control the communication module 590 and may be executed by a CPU of the hub 500E. The communication module 590 may perform communication via, for example, LAN, WLAN such as WI-FI, WPAN such as BLUETOOTH, wireless USB, ZIGBEE, NFC, RFID, PLC, or a mobile cellular network. However, exemplary embodiments of the inventive concept are not limited thereto. The communication module 590 may be, for example, the communication module 550.

The firmware 591 may provide the device application 582 and application programming interface (API), and may control the radio baseband chipset 592 according to the control of the device application 582. The radio baseband chipset 592 may provide connectivity for a wireless communication network. The secure module 527 may include the processor 527-2 and the secure element 527-3. The secure module 527 may authenticate the hub 500E to connect to the wireless communication network and to access a wireless network service. The secure module 527 may be implemented, for example, as an eMMC. However, exemplary embodiments of the inventive concept are not limited thereto.

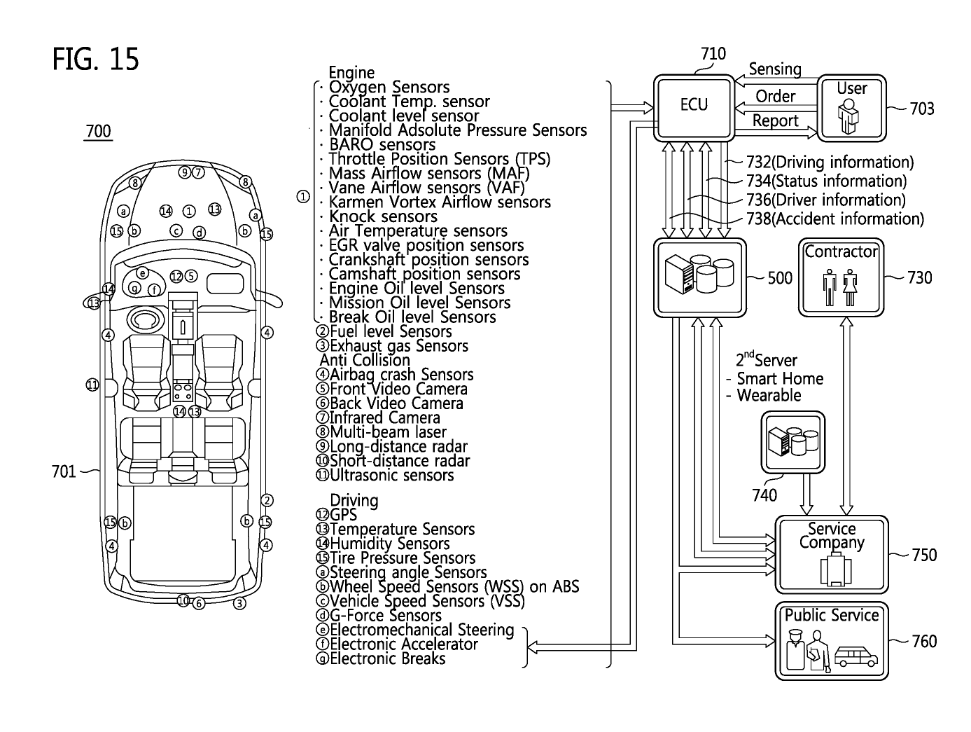

FIG. 15 is a block diagram of a data processing system 700 including the hub 500 illustrated in FIG. 1 according to exemplary embodiments of the inventive concept.

Referring to FIGS. 1 through 6 and FIG. 15, the IoT network system 700 represents a usage scenario of vehicle management, collision prevention, vehicle driving service, etc.

Referring to FIG. 15, the IoT network system 700 includes a vehicle 701 including sensors. The IoT network system 700 may also include an engine control unit (ECU) 710, a hub 500, and at least one service provider 750 and/or 760.

The sensors may include, for example, an engine unit sensor \textcircled{1}, collision prevention sensors \textcircled{4} through \textcircled{11}, and vehicle driving sensors \textcircled{12} through \textcircled{13} and \textcircled{a} through \textcircled{g}. The sensors may also include a fuel level sensor \textcircled{2} and/or an exhaust gas sensor \textcircled{3}.

The ECU 710 may gather driving information 732 output from the sensors, and may transmit the driving information 732 to the hub 500 via a communication network. The hub 500 may perform the function of a data server. In exemplary embodiments, the hub 500 may be embedded in the data server.

The ECU 710 and the hub 500 may transmit or receive vehicle status information 734, driver information 736, and/or accident history information 738 with each other. Although the hub 500 is formed outside the ECU 710 in the exemplary embodiment illustrated in FIG. 15, the hub 500 may be formed inside the ECU 710 in other exemplary embodiments. The hub 500 may transmit information from the ECU 710 to a server of the service company 750.

The server of the service company 750 may provide a user's smartphone 703 information obtained by analyzing the vehicle 701 with reference to the vehicle status information 734, the driver information 736, and/or the accident information 738 stored in the hub 500. Services provided by the service company 750 may include, for example, information about accidents on the roads, a guide to the fastest route to a destination, notification of accident handling, accident claim value calculation information, human-error rate estimation information, emergency rescue service, etc.

The server of the service company 750 may share vehicle-related information output from the hub 500 with a user 730 who has subscribed to the service. The user 730 may make a contract with the service company 750 based on the shared information.

The server of the service company 750 may receive a driver's personal information from a second server 740, and may activate an access control and service function for the vehicle 701 of the driver using the personal information. For example, the server of the service company 750 may receive NFC tag information stored in a user's wrist watch, compare the NFC tag information with NFC tag information stored in the second server 740, and unlock the door lock of the vehicle 701. The server of the service company 750 or the second server 740 may transmit the arrival information of the vehicle 701 to an IoT device installed at the user's home when the vehicle 701 arrives at the user's home.

A server of the public service provider 760 may send traffic information to an IoT device (e.g., a smartphone 703) of the driver of the vehicle 701 based on the accident history information 738 stored in the hub 500.

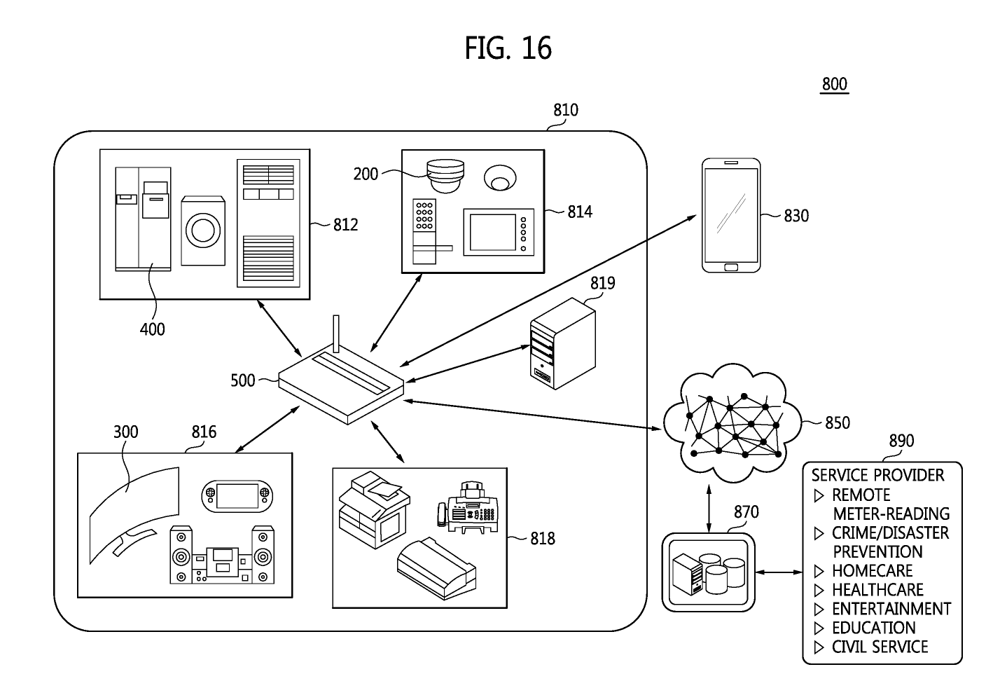

FIG. 16 is a block diagram of a data processing system 800 including the hub 500 illustrated in FIG. 1 according to an exemplary embodiment of the inventive concept.

Referring to FIGS. 1 through 6 and FIG. 16, the IoT network system 800 may include a user's smartphone 830 and a home network system 810. The home network system 810 may include IoT devices 200, 300, 400, 812, 814, 816, and 818. In exemplary embodiments, the IoT network system 800 may also include a communication network 850, a server 870, and a service provider 890.

The home network system 810 may control various kinds of IoT devices in a building (e.g., a house, an apartment, a high-rise, etc.) via a wired/wireless network, and may share contents with the IoT devices. The home network system 810 may include a hub 500, IoT devices 812, 814, 816, and 818, and a home server 819.

The home appliance 812 may include, for example, a smart refrigerator (e.g., the third IoT device 400), a smart washing machine, an air conditioner, etc. However, exemplary embodiments of the inventive concept are not limited thereto. The security/safety equipment 814 may include, for example, a door lock, a video surveillance device such as a closed-circuit television (CCTV) system (e.g., the first IoT device 200), an interphone, a window sensor, a fire detection sensor, an electric plug, etc. However, exemplary embodiments of the inventive concept are not limited thereto. The entertainment equipment 816 may include, for example, a smart TV (e.g., the second IoT device 300), an audio device, a game machine, a computer, etc. However, exemplary embodiments of the inventive concept are not limited thereto. The office equipment 818 may include, for example, a printer, a projector, a copy machine, etc. However, exemplary embodiments of the inventive concept are not limited thereto.

Each of the elements 200, 300, 400, 812, 814, 816, and 818 may be an IoT device.

The IoT devices 200, 300, 400, 812, 814, 816, and 818 may communicate with one another through the hub 500. For example, each of the IoT devices 200, 300, 400, 812, 814, 816, and 818 may transmit or receive detection data or control information with the hub 500.

The IoT devices 200, 300, 400, 812, 814, 816, and 818 may communicate (or be paired) with the hub 500 via a communication network. The home network system 810 may use, for example, a sensor network, a machine-to-machine (M2M) network, an Internet protocol (IP) based network, or a non-IP based network. However, exemplary embodiments of the inventive concept are not limited thereto.

The home network system 810 may be implemented as a home phoneline networking alliance (PNA), IEEE1394, a USB, a PLC, Ethernet, infrared data association (IrDA), BLUETOOTH, WI-FI, WLAN, ultra wide band (UWB), ZIGBEE, wireless 1394, wireless USB, NFC, RFID, or a mobile cellular network. However, exemplary embodiments of the inventive concept are not limited thereto.

The IoT devices 200, 300, 400, 812, 814, 816, and 818 may be connected to the communication network 850 through the hub 500, which may function as a home gateway. The hub 500 may convert a protocol between the home network system 810 and the communication network 850. The hub 500 may convert a protocol among various types of communication networks included in the home network system 810, and may connect the IoT devices 200, 300, 400, 812, 814, 816, and 818 with the home server 819.

The home server 819 may be installed, for example, at a home, in an apartment block, etc. The home server 819 may store or analyze data output from the hub 500. The home server 819 may provide a service relevant to the analyzed information for at least one of the IoT devices 200, 300, 400, 812, 814, 816, and 818 or the user's smartphone 830, or may transmit the analyzed information to the communication network 850 through the hub 500.

The home server 819 may receive and store external contents through the hub 500, may process data, and may provide the processed data to at least one of the IoT devices 200, 300, 400, 812, 814, 816, and 818 or the user's smartphone 830.

For example, the home server 819 may store I/O data transmitted from the security/safety equipment 814, or may provide an automatic security service or power management service for the IoT devices 812, 814, 816, and 818 based on the I/O data.

When each of the IoT devices 812, 814, 816, and 818 includes a sensor for sensing luminance, humidity, or contamination, the home server 819 may analyze data output from each IoT device 812, 814, 816, or 818 including the sensor, and may provide environment control service according the analysis result or send the analysis result to the user's smartphone 830.

The communication network 850 may include, for example, the Internet and/or or a public communication network. The public communication network may include, for example, a mobile cellular network. The communication network 850 may be, for example, a communication channel which transmits information gathered by the IoT devices 200, 300, 400, 812, 814, 816, and 818 of the home network system 810.

The server 870 may store or analyze the gathered information and may generate service information related with the analysis result, or may provide the stored or analyzed information for the service provider 890 and/or the user's smartphone 830.

The service provider 890 may analyze gathered information and may provide various services for a user according to the analysis result. The service provider 890 may provide a service such as, for example, remote meter-reading, crime/disaster prevention, homecare, healthcare, entertainment, education, civil service, etc., for at least one of the IoT devices 200, 300, 400, 812, 814, 816, and 818 or the user's smartphone 830.

For example, the service provider 890 may receive information generated by at least one of the IoT devices 200, 300, 400, 812, 814, 816, and 818 from the server 870, and may provide a service of remotely reading information related with an energy resource (such as gas, water, or electricity) based on the received information. The service provider 890 may receive information generated by at least one of the IoT devices 200, 300, 400, 812, 814, 816, and 818 from the server 870, may generate energy resource-related information, indoor environment information, or user status information based on the received information, and may provide the generated information for at least one of the IoT devices 200, 300, 400, 812, 814, 816, and 818 or the user's smartphone 830.

The service provider 890 may provide an emergency rescue service for crime/disaster prevention based on, for example, security-related information, information about fire outbreak or safety-related information, or may send the information to the user's smartphone 830. The service provider 890 may also provide entertainment, education, administration service, etc. based on information received from at least one of the IoT devices 200, 300, 400, 812, 814, 816, and 818, and may provide a two-way service through at least one of the IoT devices 200, 300, 400, 812, 814, 816, and 818.

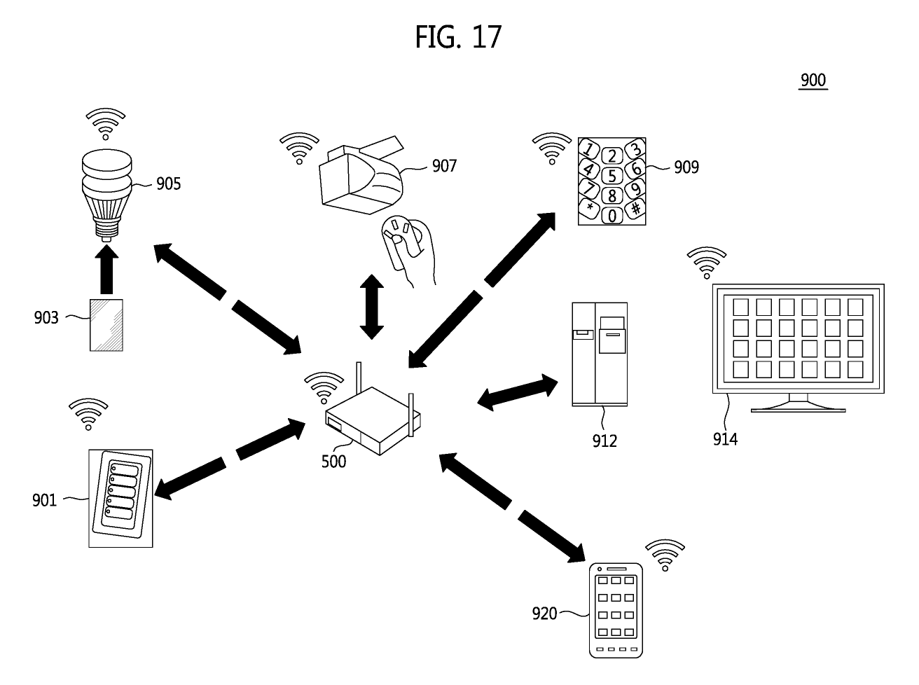

FIG. 17 is a block diagram of a data processing system 900 including the hub 500 illustrated in FIG. 1 according to an exemplary embodiment of the inventive concept.

Referring to FIGS. 1 through 6 and FIG. 17, the IoT network system 900 may be a smart lighting-network system which controls a light emitting device (e.g., a light emitting diode (LED)). For example, the IoT network system 900 may be formed using various kinds of lighting fixtures and wired/wireless communication devices, and may include, for example, a sensor, a controller, a communication unit, and a software component (e.g., software for network control and user maintenance, etc.).

The IoT network system 900 may be used in a closed space defined as an inside of a building, such as home or an office, as well as in an open space, such as a park or a street. For example, the IoT network system 900 may be implemented to gather and/or process various kinds of information output from at least one sensor, and may provide the information to a user's smartphone 920.

An LED lamp 905 included in the IoT network system 900 may receive information about a surrounding environment from the hub 500 or the user's smartphone 920, and may control its light based on the information. The LED lamp 905 may also check and control the operation state of at least one of IoT devices 901, 903, 907, 909, 912, and 914 included in the IoT network system 900 based on a communication protocol (e.g., a visible light communication protocol) of the LED lamp 905.

The IoT network system 900 may include the hub 500 which performs the function of a gateway processing data transferred according to different communication protocols, the user's smartphone 920 paired with the hub 500, the LED lamp 905, which can communicate with the hub 500 and includes a light emitting element, and the IoT devices 901, 907, 909, 912, and 914, which can communicate with the hub 500 according to various kinds of radio communication methods.

The LED lamp 905 may include, for example, a lamp communication module 903, which may function as a communication module.

The IoT devices 901, 907, 909, 912, and 914 may include a light switch 901, a garage door lock 907, a digital door lock 909, a refrigerator 912, and a TV 914.

In the IoT network system 900, the LED lamp 905 may check the operation status of at least one of the IoT devices 901, 907, 909, 912, and 914 using a radio communication network, or may automatically adjust its own luminance according to a surrounding environment or circumstance. The LED lamp 905 may also control the operation of at least one of the IoT devices 901, 907, 909, 912, and 914 using LED WI-FI (LIFI) using visible rays emitted from the LED lamp 905.

The LED lamp 905 may automatically adjust its own luminance based on surrounding environment information transmitted from the hub 500 or the user's smartphone 920 through the lamp communication module 903, or based on surrounding environment information gathered from a sensor attached to the LED lamp 905.

For example, the brightness of the LED lamp 905 may be automatically adjusted according to the type of a program on the TV 914 or the brightness of the screen of the TV 914. For this operation, the LED lamp 905 may receive operation information of the TV 914 through the lamp communication module 903 wirelessly connected with the hub 500 or the user's smartphone 920. The lamp communication module 903 may be integrated with a sensor included in the LED lamp 905 and/or a controller included in the LED lamp 905 into a module.

When a predetermined period of time elapses after the digital door lock 909 is locked with no one at home, the LED lamp 905 can be turned off according to the control of the hub 500 or the user's smartphone 920. As a result, power waste is reduced. When a security mode is set according to the control of the hub 500 or the user's smartphone 920, the LED lamp 905 is maintained in an on-state even if the digital door lock 909 is locked with no one at home.

The on/off status of the LED lamp 905 may be controlled according to surrounding environment information gathered through sensors included in the IoT network system 900. The LED lamp 905 including at least one sensor, a storage device, and the lamp communication module 903 may keep a building secure or may detect an emergency. For example, when the LED lamp 905 includes a sensor for detecting smoke, CO₂, or temperature, the LED lamp 905 may detect fire and output a detection signal through an output unit or send the detection signal to the hub 500 or the user's smartphone 920.

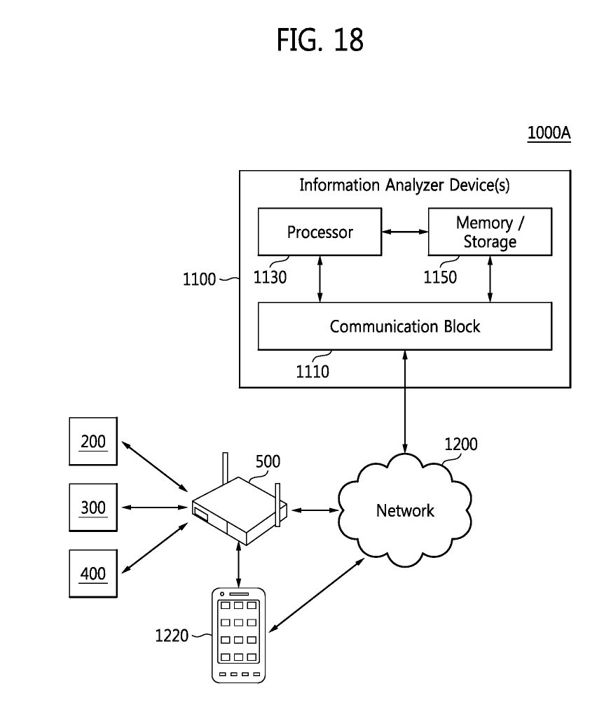

FIG. 18 is a block diagram of a data processing system 1000A including the hub 500 illustrated in FIG. 1 according to an exemplary embodiment of the inventive concept. Referring to FIGS. 1 through 6 and FIG. 18, the IoT network system 1000A may be implemented as a service system providing services for users. The IoT network system 1000A may include the IoT devices 200, 300, and 400, the hub 500, a user's smartphone 1220, a communication network 1200, and an information analyzer device 1100.

The user's smartphone 1220 may be used by a subject who requests at least one service. The user may request a service using the smartphone 1220, and may be provided with the service.

The information analyzer device 1100 may analyze information to provide a service. The information analyzer device 1100 may analyze information necessary to achieve the goal of the service. The information analyzer device 1100 may include a universal computer such as a PC and/or a dedicated computer such as a workstation. The information analyzer device 1100 may include at least one computing device. For example, the information analyzer device 1100 may include a communication block 1110, a processor 1130, and a memory/storage 1150.

The communication block 1110 may communicate with the user's smartphone 1220 and/or the hub 500 via the communication network 1200. The communication block 1110 may be provided with information and data through the communication network 1200. The communication block 1110 may transmit the result necessary to provide the service to the user's smartphone 1220 through the communication network 1200. The processor 1130 may receive and process information and data, and may output the processing result to provide the service. The memory/storage 1150 may store data that has been processed or will be processed by the processor 1130.

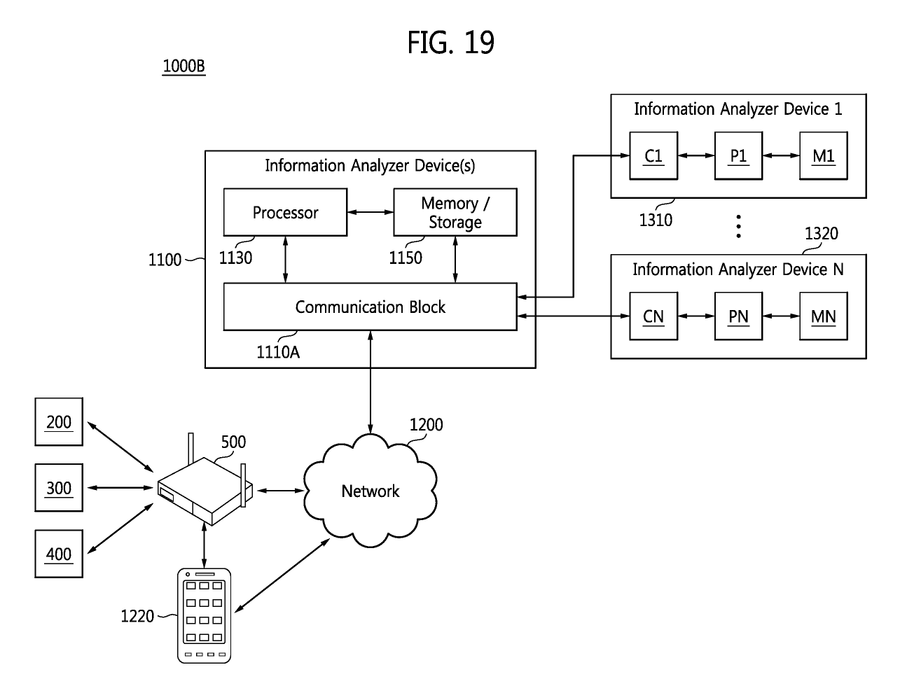

FIG. 19 is a block diagram of a data processing system 1000B including the hub 500 illustrated in FIG. 1 according to an exemplary embodiment of the inventive concept. Referring to FIGS. 1 through 6 and FIGS. 18 and 19, the IoT network system 1000B may include the IoT devices 200, 300, and 400, the hub 500, the user's smartphone 1220, the communication network 1200, the first information analyzer device 1100, and second information analyzer devices 1310 through 1320. Apart from the second information analyzer devices 1310 through 1320, the IoT network system 1000B illustrated in FIG. 19 is the same as or similar to the IoT network system 1000A illustrated in FIG. 18.

While the IoT network system 1000A illustrated in FIG. 18 includes one information analyzer device 1100, the IoT network system 1000B illustrated in FIG. 19 may also include the second information analyzer devices 1310 through 1320. The information analyzer device 1310 may include, for example, a communication block C1, a processor P1, and a memory/storage M1, and the information analyzer device 1320 may include, for example, a communication block CN, a processor PN, and a memory/storage MN.

The structure and operations of each of the second information analyzer devices 1310 through 1320 may be the same as or similar to those of the first information analyzer device 1100 illustrated in FIG. 19. Each of the second information analyzer devices 1310 through 1320 may analyze information necessary to provide a service for a user.

The first information analyzer device 1100 may manage the operation of the second information analyzer devices 1310 through 1320. The first information analyzer device 1100 may distribute information or data subjected to analysis to the second information analyzer devices 1310 through 1320. Information necessary to provide a service for a user may be processed in the information analyzer devices 1100 and 1310 through 1320 in a distributed fashion.

The first information analyzer device 1100 may include a communication block 1110A, the processor 1130, and the memory/storage 1150. The first information analyzer device 1100 may communicate with the communication blocks C1 through CN of the respective second information analyzer devices 1310 through 1320 through the communication block 1110A. The first information analyzer device 1100 may also communicate with the other elements 1310 and 1320 through the communication block 1110A. The first information analyzer device 1100 may manage and schedule the information analyzing and/or processing performed by the second information analyzer devices 1310 through 1320 according to the operations of the processor 1130 and the memory/storage 1150.

As described above, according to exemplary embodiments of the inventive concept, a semiconductor device controls an access right to a resource related with the semiconductor device according to a pairing technique used for an IoT device, thereby increasing its security level and also increasing the security level of a network system including an IoT communicating with the semiconductor device.

While the inventive concept has been particularly shown and described with reference to exemplary embodiments thereof, it will be understood by those of ordinary skill in the art that various changes in form and detail may be made therein without departing from the spirit and scope of the inventive concept as defined by the following claims.

What is claimed is:

1. A method of operating a hub, the method comprising:
receiving, by the hub, a pairing request from an Internet of Things (IoT) device;
performing, by the hub, a pairing operation with the IoT device using one authentication technique from among a plurality of predetermined pairing authentication techniques; and
assigning, by the hub, an access right to a resource to the IoT device,
wherein the access right is determined according to the one authentication technique.

2. The method of claim 1, wherein performing the pairing operation comprises:
selecting, by the hub, the one authentication technique from among the plurality of predetermined pairing authentication techniques using an authentication request signal included in the pairing request; and
evaluating, by the hub, an authentication grade for the one authentication technique.

3. The method of claim 2, wherein the authentication request signal comprises one of an identifier (ID), a password, a media access control (MAC) address, a WI-FI protected access (WPA)-related signal, a WI-FI protected access II (WPA2)-related signal, a digital signature, an ID-based encryption-related signal, and a biometrics-related signal.

4. The method of claim 2, wherein assigning the access right to the resource to the IoT device comprises:
receiving, by the hub, data from the IoT device;
analyzing, by the hub, the data;
determining, by the hub, one of a plurality of cluster types as a cluster type of the IoT device according to an analysis result of the data; and
determining, by the hub, the access right to the resource using at least one of the evaluated authentication grade and the determined cluster type.

5. The method of claim 1, further comprising:
monitoring, by the hub, a usage of the resource used by the IoT device; and
adjusting, by the hub, the access right to the resource in real-time according to a monitoring result.

6. The method of claim 1, wherein the resource comprises at least one of a bandwidth of a channel formed between the hub and the IoT device, an amount of power of the hub consumed by the IoT device, a hardware component included in the hub, a software component included in the hub, another IoT device paired with the hub, an update period of data transmitted from the IoT device, and a pairing duration time between the hub and the IoT device.

7. The method of claim 1, wherein the hub uses one of a signal strength of the IoT device, position information regarding the IoT device, and a response speed of the IoT device as the one authentication technique.

8. The method of claim 1, wherein the hub determines the access right to the resource differently according to the pairing authentication techniques.

9. A semiconductor device, comprising:
a communication module configured to receive a pairing request from an Internet of Things (IoT) device; and
a processor configured to communicate with the communication module,
wherein the processor is configured to select one authentication technique from among a plurality of predetermined pairing authentication techniques in response to the pairing request, authenticate the IoT device using the selected one authentication technique, control the communication module to facilitate pairing with the IoT device, and assign an access right to a resource to the IoT device,
wherein the access right is determined according to the one authentication technique.

10. The semiconductor device of claim 9, further comprising:
a hardware secure module configured to store the predetermined pairing authentication techniques,
wherein the processor is configured to select the one authentication technique from among the predetermined pairing authentication techniques using an authentication request signal included in the pairing request and the predetermined pairing authentication techniques stored in the hardware secure module, and evaluate an authentication grade for the selected one authentication technique.

11. The semiconductor device of claim 10, wherein the authentication request signal comprises one of an identifier (ID), a password, a media access control (MAC) address, a WI-FI protected access (WPA)-related signal, a WI-FI protected access II (WPA2)-related signal, a digital signature, an ID-based encryption-related signal, and a biometrics-related signal.

12. The semiconductor device of claim 10,
wherein the communication module is configured to receive data from the IoT device paired with the semiconductor device,
wherein the processor is configured to analyze the data output from the communication module, determine one of a plurality of cluster types as a cluster type of the IoT device according to an analysis result of the data, and determine the access right to the resource using at least one of the evaluated authentication grade and the determined cluster type.

13. The semiconductor device of claim 9, wherein the resource comprises at least one of a bandwidth of a channel formed between the semiconductor device and the IoT device, an amount of power of the semiconductor device consumed by the IoT device, a hardware component included in the semiconductor device, a software component included in the semiconductor device, another IoT device paired with the semiconductor device, an update period of data transmitted from the IoT device, and a pairing duration time between the semiconductor device and the IoT device.

14. The semiconductor device of claim 9, wherein the processor is configured to monitor a usage of the resource used by the IoT device paired with the semiconductor device, and adjust the access right to the resource in real-time according to a monitoring result.

15. The semiconductor device of claim 9, further comprising:
a hardware secure module,
wherein the processor is configured to:
check an authentication history of the IoT device using an authentication request signal included in the pairing request and authentication information stored in the hardware secure module, and to generate a confirmation signal,
select the one authentication technique from among the predetermined pairing authentication techniques in response to the confirmation signal,
authenticate the IoT device using the selected one authentication technique,
store first authentication information corresponding to an authentication result in the hardware secure module,
evaluate an authentication grade of the IoT device using the first authentication information, and
determine the access right to the resource based on the evaluated authentication grade.

16. A method of operating a hub, the method comprising:
receiving, by the hub, a first plurality of pairing requests and a first plurality of data from a first plurality of Internet of Things (IoT) devices;
receiving, by the hub, a second plurality of pairing requests and a second plurality of data from a second plurality of IoT devices;
classifying, by the hub, the first plurality of IoT devices as a first cluster type based on the first plurality of data;
classifying, by the hub, the second plurality of IoT devices as a second cluster type based on the second plurality of data, wherein the first and second cluster types correspond to different types of IoT devices;
performing, by the hub, a pairing operation with the first plurality of IoT devices using a first authentication technique from among a plurality of predetermined pairing authentication techniques;
performing, by the hub, a pairing operation with the second plurality of IoT devices using a second authentication technique from among the plurality of predetermined pairing authentication techniques;
assigning, by the hub, a first access right to a resource to the first plurality of IoT devices classified as the first cluster type; and
assigning, by the hub, a second access right to the resource to the second plurality of IoT devices classified as the second cluster type,
wherein the first and second access rights are determined according to the first and second authentication techniques.

17. The method of claim 16, wherein the first cluster type corresponds to IoT devices that gather first information, and the second cluster type corresponds to IoT devices that gather second information different from the first information.

18. The method of claim 16, wherein performing the pairing operation with the first and second pluralities of IoT devices comprises:
selecting, by the hub, the first authentication technique from among the plurality of predetermined pairing authentication techniques using an authentication request signal included in the first plurality of pairing requests;
selecting, by the hub, the second authentication technique from among the plurality of predetermined pairing authentication techniques using an authentication request signal included in the second plurality of pairing requests; and
evaluating, by the hub, an authentication grade for the first and second authentication techniques.

19. The method of claim 18, wherein the authentication request signal included in the first and second pluralities of pairing requests comprises one of an identifier (ID), a password, a media access control (MAC) address, a WI-FI protected access (WPA)-related signal, a WI-FI protected access II (WPA2)-related signal, a digital signature, an ID-based encryption-related signal, and a biometrics-related signal.

20. The method of claim 16, wherein the resource comprises at least one of a bandwidth of a channel formed between the hub and each of the IoT devices, an amount of power of the hub consumed by each of the IoT devices, a hardware component included in the hub, a software component included in the hub, an update period of data transmitted from each of the IoT devices, and a pairing duration time between the hub and each of the IoT devices.
